(19) United States
(12) Patent Application Publication
(10) Pub. No.: US 2018/0158322 A1
(43) Pub. Date: Jun. 7, 2018

(54) METHOD AND DEVICE FOR MEASURING AND PREDICTING HUMAN AND MACHINE TRAFFIC

(71) Applicant: PIGGYBACK TRANSIT INTELLIGENCE INC., San Francisco, CA (US)

(72) Inventors: Robert McDonnell, San Francisco, CA (US); Nick Mehrdad Loghmani, Toronto (CA)

(21) Appl. No.: 15/831,281

(22) Filed: Dec. 4, 2017

Related U.S. Application Data
(60) Provisional application No. 62/429,659, filed on Dec. 2, 2016.

(51) Int. Cl. G08G 1/01; G08G 1/09; G01C 21/36; H04W 4/021; H04W 4/02; H04W 8/00; G06F 15/18

(52) U.S. Cl. CPC G08G 1/012; G08G 1/0129; G08G 1/0133; G08G 1/091; G01C 21/3626; H04L 67/12; H04W 4/025; H04W 4/046; H04W 8/005; G06F 15/18; H04W 4/021

(57) ABSTRACT

A real time contextual information system is provided. In at least one example, the system may include at least one signal scanner that passively scans and detects wireless signals within a region, the wireless signals emitted from communication devices and a central processing unit (CPU) in communication with the at least one signal scanner via network connectivity. The CPU may comprise instructions stored in non-transitory memory that are executable by the CPU to receive information transmitted from the at least one signal scanner, the information based on the detected wireless signals, estimate an amount of human traffic and machine traffic at the region based on the information, and display the estimation.

### CROSS REFERENCE TO RELATED APPLICATION

This application claims priority to U.S. Provisional Application No. 62/429,659, entitled “METHOD AND DEVICE FOR MEASURING AND PREDICTING HUMAN AND MACHINE TRAFFIC,” filed Dec. 2, 2016, the entire contents of which is hereby incorporated by reference in its entirety for all purposes.

### BACKGROUND AND SUMMARY

There are many situations which may be highly impacted by one or more of human traffic and machine traffic. For example, services may benefit from being located in regions with an elevated amount of human traffic, as this elevated amount of human traffic may lead to elevated demand for their services. Further, the ability to avoid regions that have elevated traffic conditions may also be desirable in some situations, such as when trying to reduce a travel time to a location. However, as human and machine traffic is dynamic and a concentration of humans and machines in a region changes frequently and quickly, it may be difficult to navigate towards or away from such traffic. As one example, it may be difficult for a service to ensure service resources are located in elevated traffic regions, as the traffic is variable. Additionally, it may be difficult to avoid regions with elevated traffic due to the variability of the traffic.

In regards to services attempting to distribute service resources to areas of elevated demand, most of the current techniques services use to determine where to send their resources are request based, wherein a requestor may request service at a given location. However, while request based techniques for distributing resources may often be sufficient for an isolated demand, they may prove insufficient when there may be a surge in demand or rapid decrease in demand within a localized geographical region.

For example, when a special event such as a concert, convention, or a large party may be taking place, there may be a large number of attendees that may increase one or both of human and machine traffic. Specifically, shortly before the event begins and shortly after the event ends, there may be a sudden surge in traffic followed by a rapid decrease in traffic. Thus, the demand for various services within a region of said event may surge and then decrease, along with the traffic.

Services utilizing request based techniques to monitor a demand for their services may not be able to efficiently provide resources for these surges and decreases in demand. In particular, monitoring a demand for services solely based on requests may hinder a service from distributing resources to a region.

Thus, services which utilize request based techniques to monitor a demand may either be delayed in providing sufficient resources during a surge in demand or may oversaturate a geographical region with service resources during a rapid decrease in demand. Furthermore, services which alert individual service resources on a 1-to-1 basis may not assist with informing other resources of a larger potential demand or a decrease in demand.

Therefore, recognizing these issues with the above techniques, the inventors have developed a system comprising a real time contextual information collection device that includes at least one traffic sensor and a processor communicatively coupled to the at least one traffic sensor, the processor comprising a contextual traffic data module for providing traffic information collected via the at least one traffic sensor to a rule driven decision module, where the data collected via the at least one traffic sensor satisfies a specific context. In some examples, the specific context may be defined during a priming of the real time contextual information collection device, in which a rule set is uploaded to define the specific context.

The rule driven decision module may then analyze the collected traffic information to measure one or more of human traffic and machine traffic. Additionally or alternatively, the rule driven decision module may also analyze the contextual data to predict one or more of human traffic, machine traffic, and a demand for a service in a region. In at least one embodiment, the rule driven decision module may also include a navigation generating engine for generating navigational instructions based on one or more of the information collected from the at least one traffic sensor and information collected via users and third party sources. Additionally or alternatively, the navigation generating engine may generate navigational instructions based on any one or combination of the above measurements and predictions. In some examples, these instructions may be generated to direct a user towards a region where there is an elevated demand or elevated traffic. In other examples, these instructions may be generated to direct a user away from regions of elevated traffic or elevated demand.

Thus, via the system developed by the inventors, a movement of people and machines may be more accurately monitored. Additionally or alternatively, the system developed by the inventors may use the accurate monitoring of the people and machine movement to provide predictions for one or more of traffic and a demand for a service in a region. Furthermore, via the system developed by the inventors, navigational instructions may be generated based on collected traffic information. Therefore, via the above system, users may navigate towards regions with an elevated concentration of people, or, if desirable, avoid regions that may be crowded.

In one example, the system may facilitate the collection of real time contextual information about human traffic and machine traffic and the presence of such traffic in a given context. In some examples, the context may be provided during a priming of the real time contextual information collection device.

In some embodiments, the information about human and machine traffic may be determined based on wireless signals emitted from communication devices used by humans or machines that may be detected via the traffic sensors of the real time contextual information collection device. The system may further provide automatic collection of the real time contextual information such that user interaction may not be necessary. For example, the traffic sensors of the real time contextual information collection device may automatically collect real time contextual information, so that user interaction may not be necessary.

In one embodiment, a rule driven decision module may analyze the data collected via a cloud-native actionable demand intelligence platform, referred to herein as a Demand Analytics Engine (DAE). The DAE may comprise a crowd sensing and serving ability and may provide a plurality of services such as crowd analysis and prediction, and demand analysis and prediction based on the collected data. Additionally, the DAE platform may include a plurality of demand models for analyzing the collected data which may enable streamlined operations, increased revenue, and better service to all users including vendors.

In one embodiment, the rule driven decision module described above may utilize analytical processes such as big data modeling, machine learning, and/or predictive analytic technologies (available from a variety of source data). In some examples, the rule driven decision model may be primed in order to perform a particular analysis. For example, in some embodiments the rule driven decision module may receive an uploaded rule set priming the rule driven decision module to perform a desired analysis, such as one or more of an analysis on human traffic, machine traffic, and demand for a service in a region. This priming of the rule driven decision module may also include uploading a rule set to define a context in for analyzing collected traffic information. For example, uploading rules to define a specific context may include but not be limited to providing a specific geographical location or location range also referred to herein as a “geo-fence,” a time of day, weather conditions, a classification of communication devices whose emitted wireless signals are to be collected, velocity limits, communication device density, or similar contextual information. Additionally or alternatively, event and mapping application program interfaces (APIs), and user generated data may be utilized to aggregate and analyze data in the context of demand or predicting a concentration of people.

The rule driven decision module may include a navigation generating engine to further perform “sense” engine operations which may generate navigational data to direct users in a direction where there may exist an increased opportunity to secure customers. In other examples, the rule driven decision module may generate navigational data to direct users away from regions with elevated traffic.

Thus, the real time contextual information collection device described in the above example systems may collect a granular data set, and this granular data set may be analyzed in various manners to predict one or more of human traffic, machine traffic, and a demand for a service in a region. Further, the above described system may generate navigational data based the collected granular data set and may display this navigational data to instruct a user on how to navigate towards a crowded region (i.e., elevated traffic region) or to avoid such a region.

The present subject matter further relates to a traffic information system and methods for detecting and predicting one or more of an amount of human traffic, machine traffic, and a demand in a region, such as a demand for a service.

A first example method may include passively collecting traffic information and predicting one or more of a concentration of human traffic and machine traffic in a region based on the collected traffic information. The method may further include predicting a demand in a region based on the collected traffic information. Additionally or alternatively, the predictions may be based upon user reporting. For example, the predictions may be based at least in part upon user reporting that verifies one or more of traffic conditions and demand conditions. In some examples, the method may further include generating a response based on the predictions.

Additionally or alternatively, the method may include generating navigational data to direct a user based on one or more of the collected traffic information, user reported conditions, and a request, such as a request to be routed towards regions of elevated traffic or elevated demand, or a request to be routed to avoid regions of elevated traffic. As discussed above, the user reported conditions may include user reporting that verifies one or more of traffic conditions and demand conditions, in some examples.

In one embodiment, the data collected may be wireless signals emitted from communication devices operated by human and/or machine users, and these wireless signals may be collected via traffic sensors of the real time contextual information collection device. The passively collected data may provide information related to the location of said communication devices, the density of communication devices, type of devices, and other contextual information. Therefore, a concentration of people in a region may be determined based on the passively collected data, and a concentration of machines in a region may be determined based on the passively collected data. The method of passively collecting data may be referred to herein as “swarm capability” or “crowd sensing.”

A second method for measuring and predicting one or more of an amount of human traffic and machine traffic in a region and a service demand in a region, which may additionally or alternatively include the first example method, may utilize data from public sources and third-party APIs in order to predict when and where sudden surges or decreases in demand may occur. Additionally, this data collected from public sources and third-party APIs may be utilized in order to predict an increase or a decrease in a concentration of people in a region. Additionally or alternatively, this data collected from the public sources and third-party APIs may be utilized in order to predict an increase or a decrease in a concentration of machines in a region.

The subject matter disclosed herein relates to mechanisms for measuring and predicting one or more of traffic conditions and demand conditions. For example, the traffic conditions may include one or more of human traffic and machine traffic, and the demand conditions may include demand for a service. The first may utilize crowd-sourced data from service providers in order to indicate the location and scale of potential sudden surges in demand for a service. A second mechanism of the present subject matter may utilize data from public sources and third-party application programming interfaces to predict when and where sudden surges in demand for a service may occur. This prediction information may be used to bootstrap more refined data via the swarm mechanism.

Thus, via the system and methods provided herein, this traffic sensing, also referred to herein as crowd sensing, may be enabled, and this traffic sensing may enable temporal and spatial awareness for a service provider. This awareness of people and devices in the context of time and space is a crucial aspect and a key capability in the modern service oriented economy. Furthermore context aware traffic sensing where the combination of hardware, such as the real time contextual information collection device, and software, such as the rule driven decision module, can be primed to look for “patterns of interest” among the crowd (of people and devices) enables real time adaptive and reactive services to be provided as demand patterns start to emerge. This approach allows for not only better predictive services but for adoption and reaction to emerging patterns based on real time data.

It should be understood that the summary above is provided to introduce in simplified form, a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 illustrates an example real time contextual information collection device.

FIG. 2 is a process flow diagram illustrating the communication protocols within a traffic information system.

FIG. 3 illustrates an example schematic of a signal scanner for use with a traffic information system.

FIG. 4 illustrates a method performed by an example traffic information system.

FIG. 5 illustrates an example computing system to be used with a traffic information system.

FIG. 6 illustrates a first example network architecture for a traffic information system.

FIG. 7 is a block diagram illustrating a processor in accordance with example embodiments of the present disclosure.

FIG. 8 shows a schematic diagram illustrating a first example network architecture for a traffic information system.

FIG. 9 shows a block diagram illustrating a first example server system in accordance with example embodiments of the present disclosure.

FIG. 10 shows a block diagram illustrating a method for swarm reporting relating to a traffic information system.

FIG. 11 shows a block diagram illustrating a method for swarm verification.

FIG. 12 shows a block diagram illustrating a method for swarm dissipation.

FIG. 13 shows a block diagram illustrating a method of incorporating third-party data into the demand analytics engine.

FIG. 14 shows an example computing system relating to a demand analytics engine.

FIG. 15 shows a schematic diagram illustrating a second example network architecture for a traffic information system.

FIG. 16 shows a block diagram illustrating a second example server system in accordance with example embodiments of the present disclosure.

FIG. 17 shows a second example network architecture for a traffic information system.

FIG. 18 shows a flow chart of a first example method for measuring and predicting one or more of an amount of human and machine traffic.

FIG. 19 shows a flow chart of a second example method for measuring and predicting one or more of an amount of human and machine traffic.

### DETAILED DESCRIPTION

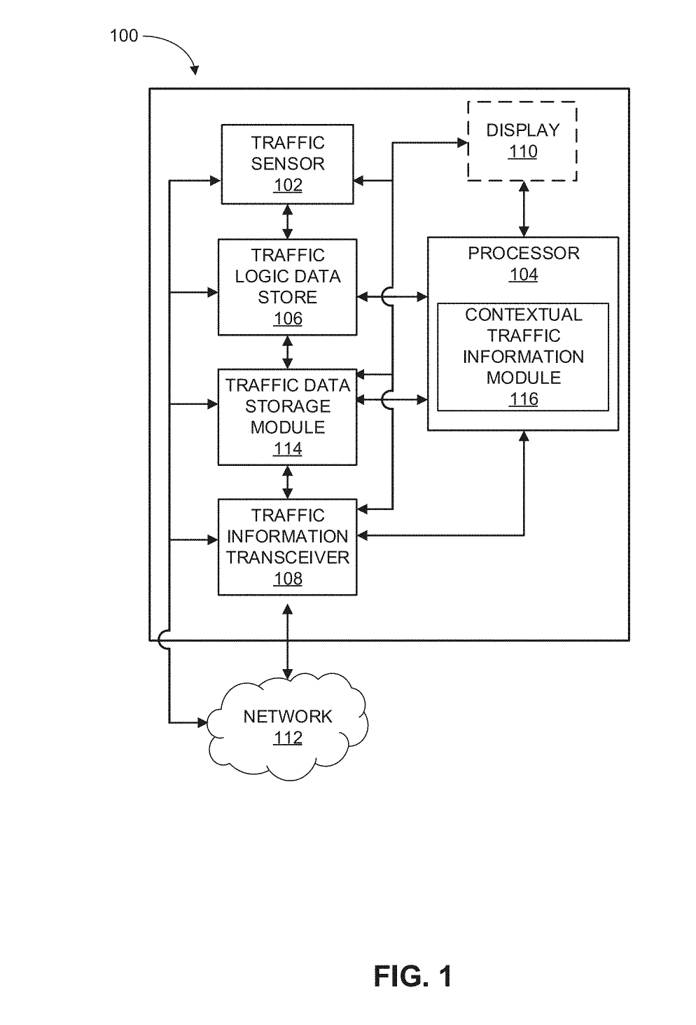

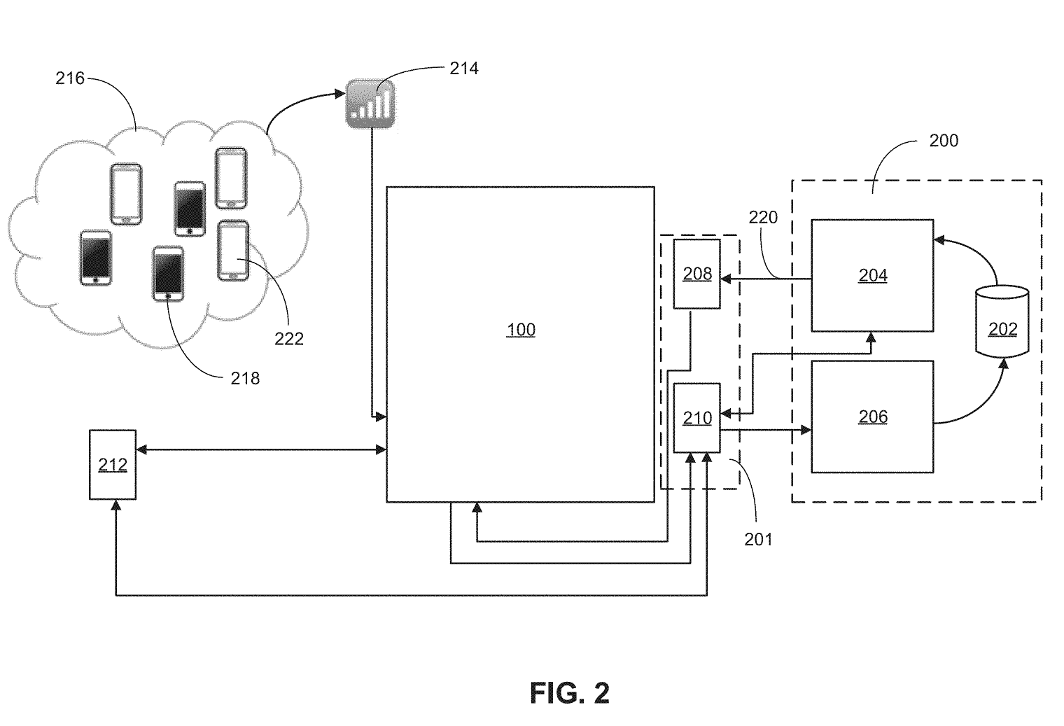

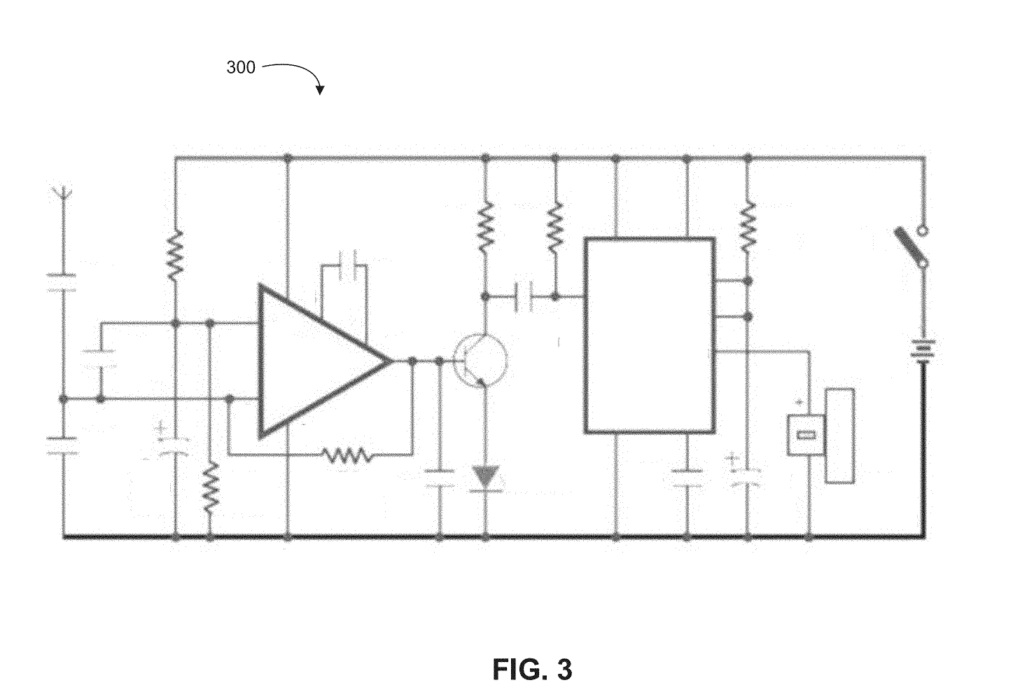

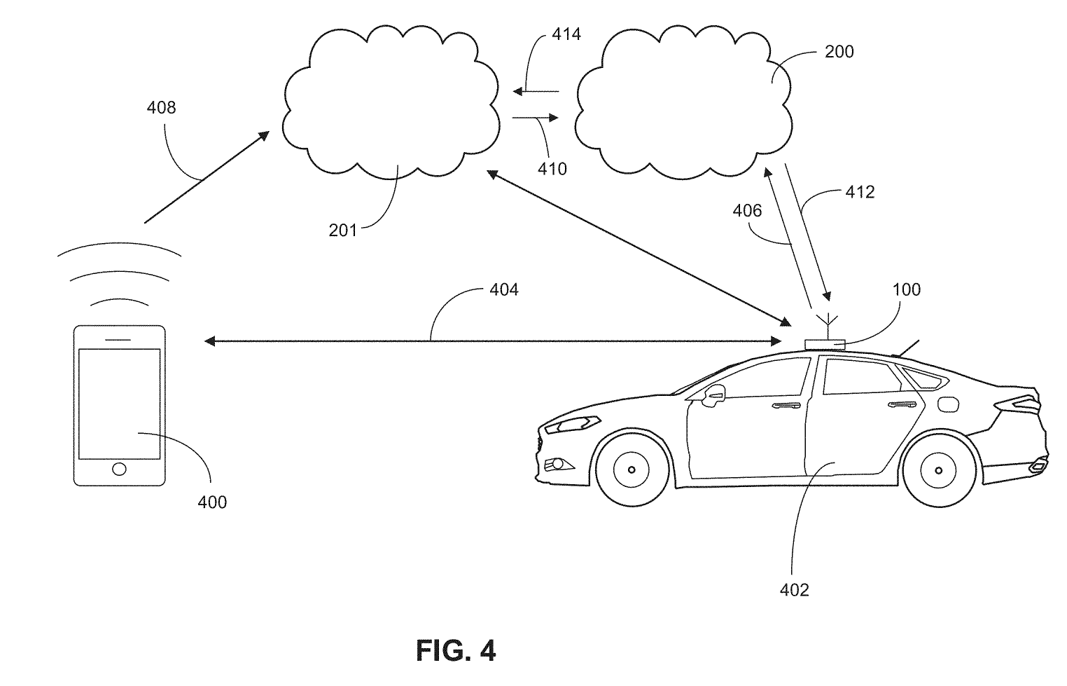

The present disclosure relates to systems and methods for measuring and predicting one or more of human traffic, machine traffic, and a demand for a service in a region. In some examples, the system may include a real time contextual information collection device as illustrated in FIGS. 1 and 3 in order to collect a granular set of traffic information to be used for analysis. The traffic information may be based off of wireless signals that may be detected via a traffic sensor of the real time contextual information collection device, for example. In some examples, this traffic information may be used as a part of a traffic information system for measuring and predicting one or more of human traffic, machine traffic, and a demand for service in a region. In particular, the real time contextual information collection device may be a part of the traffic information system, and the real time contextual information collection device may communicate with various components of the traffic information system as described at FIGS. 2, 5, 7-9, and 14-17 for measuring and predicting one or more of traffic and a demand for a service in a region. In some examples, one or more of user reported information and third party information may be utilized for measuring and predicting one or more of traffic and the demand for a service in a region. Additionally or alternatively, the traffic information system may generate navigational directions based on the granular data set. The traffic information system may be operated according to various example methods as described at FIGS. 4 and 10-13 in order to measure and predict one or more of human traffic, machine traffic, and a demand for a service in a region. In some embodiments, the methods for operating the traffic information system may include communicating with communication devices.

The embodiments of the present disclosure may be implemented in some examples to provide service providers with a mechanism to remotely and automatically offer services to prospective clients in real time via a network connected device configured to access the network-based application. However, the systems and methods provided may be applicable to any situation in which tracking of one or more of human and machine traffic and a demand for a service may be beneficial.

For example, in embodiments that may be implemented to provide vendors such as service providers and dispatch services with the ability to sense crowds, the traffic information system may provide vendors with the ability to remotely and automatically identify instances of sudden surges in demand as well as predict where areas of demand surges may occur in the future. The crowd sensing and prediction capability may be communicated via the network connected device, whereby the network based application facilitates a notification to vehicle operators alerting them of the location and size of a reported “swarm.” It will be understood that as used herein, the term “swarm” refers to a sudden surge or an increased demand for a service.

It should be further understood that various aspects of example embodiments provided in the present description may be implemented with respect to any suitable class and/or type of services and products that may be offered by any suitable class and/or type of service providers. Additionally or alternatively, various aspects of example embodiments provided in the present description may be utilized for any situation in which one or more of measuring and predicting traffic and demand may be beneficial.

As one example, a traffic information system may present service providers with a crowd sensing capability which may comprise a real time view of the current demand for their service. In providing a current real time view of the current demand, the supply of service resources to particular regions may be increased or decreased according to the current demand. It will be appreciated that the traffic information system may also provide insight into future predicted swarms. For example, the traffic information system may passively collect data such as wireless signals emitted from communication devices and may pair the collected wireless data with data sourced from third-party APIs. The collected wireless data and API data may then be aggregated and analyzed to provide a user with information pertaining to a predicted swarm event such as the types of communication devices present, the location, density, velocity, and other contextual information of the predicted swarm.

FIG. 1 illustrates a block diagram of a real time contextual information collection device which may be a part of a traffic information system. In at least one embodiment, the real time contextual information collection device may be physically coupled to a vehicle. For example, the real time contextual information collection device may physically coupled to a vehicle via a mount. Additionally or alternatively, the real time contextual information collection device may be coupled to be positioned anywhere that traffic information such as wireless signals may be detected. For example, the real time contextual information collection device may be coupled to stationary objects such as buildings and lamp posts.

The real time contextual information collection device may be configured to communicate to the traffic information system via connectivity to a network 112 such as the internet.

The real time contextual information collection device 100 may comprise at least one traffic sensor 102, a processor 104, a traffic logic data store 106, a traffic data storage module 114, and a traffic information transceiver 108. The traffic sensor 102 may be signal scanner, in some examples. The traffic sensor 102 may detect wireless signals and utilize these signals as traffic information. Additionally, the traffic information transceiver 108 may be a wireless transceiver.

In some examples, the real time contextual information collection device may further comprise a display 110. However, in other examples, the real time contextual information collection device may not comprise a display. For example, rather than the real time contextual information collection device 100 having a display 110, the device 100 may communicate with other devices and provide displays on the other devices via communication over a network 112. However, in some examples the real time contextual information collection device may not provide any displays at all. For example, in some examples, the real time contextual information collection device may communicate with a computing system of an autonomous vehicle, and a display may not be necessary. In example real time contextual information collections devices that may include a display 110, the display 110 may be configured to receive a user input. However, in other examples that include a display 110, the display 110 may not be configured to receive a user input. Additionally or alternatively, the real time contextual information collection device may receive a user input via wireless communication. For example, a user may utilize a communication device to provide an input to the real time contextual information collection device.

The real time contextual information collection device 100 may be configured to scan for and to receive a plurality of wireless signals. For example, the at least one traffic sensor 102 may be a wireless signal scanner, and the wireless signal scanner 102 may be configured to scan for cellular radio signals, Wi-Fi signals, Bluetooth signals, or any other radio, wireless, or near-field communication signals or a combination thereof. Thus, the traffic sensor 102 may detect both human and machine traffic, as signals of tied to cars and cellular phones may be detected via the traffic sensor 102, for example. These wireless signals that may be sensed via the at least one traffic sensor 102 may be utilized as traffic information.

The real time contextual information collection device 100 may be primed in order to define a specific context for traffic information collection. In some examples, priming the real time contextual information collection device 100 may include uploading rules for traffic information collection. For example, these rules for traffic information collection may define a specific context for collecting traffic information via the real time contextual information collection device, such as via the at least one traffic sensor 102 described above. Uploading rules to the contextual information collection device may include but not be limited to providing a specific geographical location or location range also referred to herein as a “geo-fence,” a time of day, weather conditions, a classification of communication devices whose emitted wireless signals are to be collected, velocity limits, communication device density, or similar contextual information. These rules may be saved at the traffic logic data store 106 as non-transitory instructions that are executable by a processor of the at least one traffic sensor 102, for example. In some examples, priming the real time contextual information collection device may include uploading a rule set that includes all traffic information, such as all wireless signals detected via the at least one traffic sensor 102, for processing.

Uploading rules such as the ones above to define specific contextual information for priming the real time contextual information collection device may be achieved by receiving a user input through a display 110. In some examples, the rules may additionally or alternatively be received by a traffic information transceiver 108 via a network 112.

Once the real time contextual information collection device has been primed, each of the at least one traffic sensors 102 may only collect traffic information (e.g., wireless information as described above) that satisfies the rules uploaded during the priming in some embodiments. In some examples, the uploaded rules defining specific contextual information for priming the real time contextual information collection device may be stored in traffic logic data store 106. Further, in one embodiment, though not shown, the at least one traffic sensor 102 may include a processor that is able to communicate with the traffic logic data store 106 to determine which type of information to collect, then the at least one traffic sensor 102 may only collect information (e.g., wireless information as described above) that satisfies the uploaded rule set.

In some embodiments, each of the at least one traffic sensor 102 may only scan for signals that satisfy the uploaded rules. Thus, the real time contextual information collection device may only gather information that satisfies specific contextual information as defined by the uploaded rule set during the priming. This may be advantageous for reducing an amount of information that may need to be stored by the traffic data storage module 114. Additionally, only collecting information that satisfies the rules uploaded during the priming step may simplify a workload for a processor 104 of the real time contextual information collection device. In particular, processing may be simplified for a contextual traffic information module 116 of the processor 104, where the contextual traffic information module 116 determines which data to transmit to a rule driven module of the traffic information system.

Additionally or alternatively, priming the real time contextual information collection device may include uploading rules for specific context information via any one or combination of the above described manners and storing the specific context information in traffic logic data store 106. Then, each of the at least one traffic sensors 102 may collect information that satisfies and does not satisfy the uploaded rules, and the collected data may be filtered following the collection.

For example, the traffic information collected via the at least one traffic sensor 102 that satisfies and does not satisfy the uploaded rules (i.e., unfiltered data) may be stored in traffic data storage module 114. Then, following storage of the unfiltered traffic information, processor 104 may filter the collected traffic information based on the uploaded rules. In some examples, the uploaded rules for defining specific contextual information may be stored in traffic logic data store 106, and the traffic logic data store 106 may be accessed in order to filter the traffic information stored in traffic data storage module 114. For example, the contextual traffic information module 116 of processor 104 may access the traffic logic data store 106 in order to access the uploaded rules to filter the data stored in traffic data storage module 114.

Embodiments where each of the at least one traffic sensors 102 collects traffic information that satisfies and does not satisfy the uploaded rule set may be advantageous for performing multiple analyses. For example, by applying the uploaded rule set following collection of traffic information that satisfies and does not satisfy the uploaded rule set, the uploaded rule set may be later modified and still be able to use the stored traffic information.

In some embodiments, a user may utilize a computing device such as a smartphone or any other suitable device configured to communicate to the real time contextual information collection device via network connectivity 112. In some examples, a user may transmit a specified context (i.e., rule set) to the device′ transceiver 106 using a computing device. The traffic information transceiver 108 may then transmit the contextual information to a traffic logic data store 106 and at least one traffic sensor 102.

It will be appreciated that the traffic information transceiver 108 may communicate directly with both the processor 104 and the traffic logic data store 106 and that the traffic information transceiver 108 may also communicate with exterior communication devices and networks such that the information collected and stored by the real time contextual information collection device is relevant and may be updated in real time.

Once the processor 104 receives data from one or both of the traffic information transceiver 108 and the traffic logic data store 106, a contextual traffic information module 116 of the processor 104 may then aggregate and analyze the data such that the data may be related to the uploaded rules defining a specific information context previously determined during the priming process. The contextual traffic information module 116 of the data processor 104 may then relay the contextual traffic information (i.e., filtered traffic information) back to the traffic information transceiver 108. The traffic information transceiver 108 may then transmit the simplified contextual traffic information over a network connection to a user via a communication device such as a smartphone or tablet. In other words, via the real time contextual information collection device, traffic information may be collected and then simplified prior to being transmitted a rule driven decision module of the traffic information system.

In at least one embodiment, the real time contextual information collection device may scan for and subsequently collect a plurality of wireless signals emitted from communication devices passively and anonymously. For example, passive information collection may enable the real time contextual information collection device to collect and store information associated with the communication devices such as movements and velocity via an accelerometer, a geographical location via GPS capability, application usage, network connectivity, IP address, operating system, behavior in the application, and other such information which may assist with identifying a surge or a potential surge in a demand for a service, referred to herein as a “swarm.” Additionally, this passively collected information may be used to identify one or more of human traffic and machine traffic or to predict future traffic conditions.

Thus, these wireless signals are passively collected traffic information, and this passively collected traffic information may be communicated to a processor 104 of the real time contextual information collection device in some examples. This passively collected traffic information may also be stored in some examples. For example, this passively collected traffic information may be stored in traffic data storage module 114.

In some examples, the real time contextual information collection device may include a display 110 that displays the simplified contextual traffic information on the real time contextual information collection device, alternatively or in addition to transmitting the simplified contextual data over a network connection to a user via a communication device. Additionally or alternatively, the simplified contextual data may be transmitted to a rule driven decision module of the traffic information system. Further, in some examples, the simplified contextual data may be displayed by the communication devices.

In FIG. 2, an example process flow diagram illustrating the communication protocols within a traffic information system is provided. As shown in FIG. 1, the traffic information system may comprise a real time contextual information collection device and a rule driven decision module 200. As discussed above, the real time contextual information collection device may transmit collected contextual information to the rule driven decision module 200.

In one embodiment, the rule driven decision module may analyze information collected via a cloud-native actionable DAE. In some examples this collected information may include traffic information collected via the real time contextual information collection device. Additionally or alternatively, the collected data may include one or more of user reported information and third party information. The DAE may comprise a traffic sensing and serving ability and may provide a plurality of services such as traffic measurement and prediction, and demand measurement and prediction based on the collected data. Additionally, the DAE may include a plurality of demand models for analyzing the collected data which may enable streamlined operations, increased revenue, and better service to all users including vendors. In one example, the DAE may comprise a transportation DAE. The transportation DAE may comprise one or more demand models which may be used to compare against and analyze current and/or future transportation demand conditions.

The rule driven decision module 200 may comprise a decision support module 206, an adaptive decision module 203, and a real time decision module 204. The traffic information system may further comprise a registry 201 comprising a device registry 208, and an event registry 210. The traffic information system may operate in at least one embodiment responsive to input from a user such as an event subscriber 212 which may determine and set rules and/or context for information collection. An event subscriber may comprise any user of the traffic information system. For example, a consumer (such as a passenger of a transportation service) may utilize the traffic sensing capability of the traffic information system to avoid areas of increased demand such as busy bus stations or intersections in order to get a better estimated service time and/or price based on the traffic density of certain locations.

As an example, a user 212 may provide a specific set of rules and contextual parameters to the traffic information system via the real time contextual information collection device's traffic information transceiver 108 which may receive and subsequently transmit the data to a plurality of modules and components within the traffic information system. In one embodiment, once the traffic information transceiver 108 acquires the predetermined rules and/or context for information collection, this information may then be transmitted to an event registry 210 of the traffic information system's registry 201. The event registry 210 may then analyze the supplied information and compare it against information stored in the event registry which may be provided by third party APIs or other crowd-sourced information for example. Once the event registry 210 compares against crowd-sourced or third party API data, the collected and aggregated information may then be relayed to the rule driven decision module 200 via the decision support module 206. The decision support module may be configured to verify the collected information.

Further, the rule driven decision module may be configured to apply a set of predefined rules to patterns of received information as enforced by a registered party such as a system administrator. For example, these predefined rules to patterns may be uploaded to the rule driven decision module as a part of a priming of the rule driven decision module. Priming of the rule driven decision module may include uploading a rule set for the rule driven decision module to perform a desired analysis, such as one or more an analysis on human traffic, machine traffic, and demand for a service in a region, in some examples. Additionally or alternatively, priming of the rule driven decision module may also include uploading a rule set to define a context in for analyzing collected traffic information.

For example, uploading rules to the rule driven decision module during priming to define a specific context may include but not be limited to providing a specific geographical location or location range also referred to herein as a “geo-fence,” a time of day, weather conditions, a classification of communication devices whose emitted wireless signals are to be collected, velocity limits, communication device density, or similar contextual information. Additionally, the rule driven decision module may further be configured to adopt and infer rules in an adaptive manner based on the occurrence frequency of emerging patterns and or feedback from registered parties. Thus, in some examples, the rule driven decision module may further filter traffic information that is received from the real time contextual information collection device in some examples. Additionally the rule driven decision module may be primed with a rule set to utilize all available traffic information regardless of the above discussed rules that may be used to define a specific context. In at least one embodiment, the rule driven decision module may be primed with a rule set to utilize all available traffic information communicated by the real time contextual information collection device, user reported traffic information, and third party information. In other examples, the rule driven decision module may be primed with a rule set to utilize any one or combination of traffic information from the real time contextual information collection device, user reported traffic information, and third party information.

It will be appreciated that a registered user may comprise a system administrator or another party having an interest in the decision formed by the rule driven decision module. The collected information may then be relayed to an adaptive decision module 203 which may be configured to pair the collected information with the provided context and/or rules provided by a user. The adaptive decision module may then transmit the verified and paired collected data to a real time decision module 204 which may be configured to form a decision relating to alerting users of a swarm or predicted swarm to a registry 201 of the collective traffic information system via a device registry which may be configured to recognize and differentiate between different types of communication devices. The device registry may then supply the collected and refined information back to the information collection device via the device's traffic information transceiver 108. Once the information collection device obtains the collected and refined information, an alert may be provided to a user such as an event subscriber 212 via transmission from the device's traffic information transceiver 108.

In some embodiments, the collective traffic information system may perform passive traffic information collection automatically. For example, the at least one traffic sensor (e.g., a scanner) 102 of the real time contextual information collection device 100 may utilize an antenna to scan for and subsequently collect wireless communication information emitted by one or more communication devices 216, where this wireless communication information may be used as traffic information. The plurality of communication devices 216 may emit wireless signals such as radio cellular signals, Wi-Fi signals, Bluetooth signals or any other wireless signals that may facilitate data transmission. As one example, one or more communication devices 216 may emit cellular network signals 214 which may be collected by the scanner 102 of the real time contextual information collection device 100. The real time contextual information collection device 100 may collect this wireless data as traffic information based upon an uploaded rule set, as described above. Then the real time contextual information collection device may transmit the collected traffic information to the registry 201 and to the rule driven decision module 200.

In some examples, based upon the uploaded rule set, the real time contextual information collection device 100 may simplify traffic information collected via the device prior to sending the information to the rule driven decision module 200. Once the data is collected, aggregated, and analyzed by the registry 201 and the rule driven decision module 200, the collected wireless data emitted by the one or more communication devices 216 may then be associated with a set of rules and parameters that define the context of the traffic information system.

An example of passive data collection by the real time contextual information collection device 100 may be that the at least one traffic sensor 102 (e.g., a scanner) may collect the emitted data from a plurality of communication devices 216 and may transmit the collected data to the real time contextual information collection device which may communicate with the traffic logic data store 106 to determine if the collected data is usable data or not. The traffic logic data store 106 may determine if the collected data is usable or not based on rules uploaded by a user to the traffic logic data store 106 in some examples. For example, if a user such as a transportation provider wants to collect data from only communication devices with an Android operating system 222, these rules may be uploaded to the real time contextual information collection device in any of the above described manners, and the real time contextual data collection device ignore or filter out data from iOS devices 218. In some examples, the at least one traffic sensor 102 may only collect data that meets the criteria set by the uploaded rules. In other examples, however, the at least one traffic sensor 102 may collect data regardless if it satisfies the set of criteria created by the uploaded rules, and then the collected data may be stored in data storage module 114 and subsequently filtered via the contextual information module 116 based on rules uploaded to the traffic logic data store 106.

It will be appreciated that the passive traffic information collection operation described above may collect information in the form of wireless signals that are continuously emitted by wireless devices while connected to a network. During passive scans, the at least one traffic sensor, which may be a scanner, “listens” for beacons and/or probe responses emitted by communication devices. Passive scanning via the at least one traffic sensor 102 may be beneficial because communication devices typically utilize another form of passive scanning to connect to wireless access points. The information may be collected anonymously and without actually forming a communication path with the one or more communication devices whose data is being collected. In this way, the traffic information system may provide updated, real time contextual information to users of the system without delay.

The traffic information system provided may be useful for any situation in which tracking a movement of people and/or machines may be beneficial. For example, a police force may distribute resources to various regions based on a predicted amount of people or machines in the regions. As one example, the traffic information system may determine a demand for police force resources based on human and machine traffic, and the police force resources may be directed to particular regions based on the demand. Thus, oversaturation of forces in some areas may be avoided, and regions requiring additional police force resources may be better served.

Additionally, the traffic information system provided may be useful for determining traffic within a building. For example, large department stores may be able to use a measured and/or a predicted movement of people in order to more efficiently distribute associates to various departments.

In another example, the traffic information system may be useful for directing people to exits of a building based on one or more of measured and predicted traffic. For example, in case of a large building with many exit paths (e.g., an arena) a navigation generating engine of the rule driven decision module may generate navigational directions to direct people towards exits while avoiding crowded regions of the building.

Further, the traffic information system may be useful for distribution of resources in a theme park. For example, the traffic information system may measure and predict a movement of people within the theme park, and then based on the measured and predicted movement of the people, the theme park may take mitigating action to direct guests of the theme park to avoid crowded areas. Additionally or alternatively, the traffic information system may determine a demand for particular services that the theme park provides (e.g., food service, ride operations, custodial, etc.) and the appropriate employees may be distributed based on the determined demand for these particular services. For example, if a region of the theme park is determined to have a heightened demand for food service, more food service employees may be directed towards that region of the theme park.

In some examples, the real time contextual information collection device described may be applied in the transportation industry. Thus, the communication devices with which the contextual traffic information system communicate may be communication devices of transportation providers.

In some embodiments, the transportation providers may be autonomous vehicles. In other examples the transportation providers may be drivers. For example, the drivers may public transit drivers or taxi drivers.

The current state of the taxicab industry has been largely disrupted by the ride-sharing model of recent startups. Thus, many taxicab operators experience significant competition from ride-sharing companies such as Uber and Lyft which provide both passengers and vehicle operators with up-to-the-minute information regarding the location of vehicles waiting for a fare. Additionally, it is estimated that taxicabs operate without a fare roughly 45% of the time relative to the amount of miles actually traveled.

When a taxi or other such transportation service provider operates without a fare, revenue may be lost even though a demand for transportation may exist elsewhere. With the current taxi market in the United States being a roughly 15 billion dollar industry annually, and having in excess of an estimated 200,000 taxi and limousine companies comprising the industry, there exists a substantial demand for actionable insights based on when and where transportation demand exists in real time.

Via the described real time contextual information collection device, information may be passively collected to enable the traffic information system to quickly and accurately predict human and machine traffic. Thus, the above mentioned example transportation providers may be able to serve areas that may have a greater demand. Additionally, the transportation providers may be able to avoid regions predicted to have elevated human and/or machine traffic. Avoiding regions predicted to have elevated traffic may be beneficial for quickly transporting people to a location, for example.

The system and methods provided herein provide a substantial improvement in an efficiency for distributing service resources over traditional manners, particularly the transportation industry. For example, the provided system and methods may be substantially more efficient over traditional hailing of taxicabs, calling a transportation dispatch service, or request based systems which utilizing mobile or web applications to request a pickup.

Using ride dispatch services may limit the availability and timeliness of transportation available to a ride requestor due to a lack of real time feedback. For example, when a ride requestor calls a taxi dispatch service, the taxis that may be available to the requestor may be limited to a specific company or a specific localized geographical location. In this way, even though there may be other ride service providers that may be able to provide the requestor with a ride sooner, or may be closer relative to the transportation provider notified by the dispatch service, the requestor may not be immediately aware of the alternative options, and therefore, may be limited in their available transportation options.

Further, prior methods of providing transportation demand data to a transportation service provider are typically fragmented in nature, meaning that the methods rely on historical data, or information collected subsequent to a user interacting with an application on an electronic device such as a smartphone for example. Methods relying primarily on historical data and/or data supplied by user input may typically be supplied after observing a surge in ride demand and may not take into account future, or current swarms and may further neglect users seeking information about a swarm or potential future swarm that may not have the application running on their electronic device.

Additionally, a transportation service provider may not be able to access a communication device such as a smartphone for example, while operating a vehicle. In such an instance, a real time contextual information collection device as provided herein, may automatically collect, aggregate, and/or analyze a wide variety of wireless signal information emitted by other communication devices. In this way, a transportation service provider may utilize the real time contextual information collection device and traffic information system to continuously collect information pertinent to transportation demand, even when operating a vehicle for example. Further, as the information collection by the system and device may be automatic in nature, potential swarms may be continuously predicted and the prediction may allow for fewer instances of operation without a fare on the part of the transportation service provider. As an example effect of the traffic information system, a vendor, such as a transportation service provider, may be able to increase revenue due to an increase in fares. It will be appreciated that a vendor may comprise a service provider such as a taxicab company, a taxicab dispatch service, ride-sharing programs, or other service providers.

It will be appreciated that as used herein, a “vehicle operator” may refer to a driver of a vehicle or a remote vehicle operator. A remote vehicle operator may refer to a vehicle operator that may not be physically present in the subject vehicle providing transportation services. Additionally, a driver may include an autonomous vehicle, and/or a related system for the autonomous vehicle, wherein the vehicle may provide transportation services. Further, an autonomous vehicle may refer to a vehicle providing transportation services that may be self-driven or may not require a human operator. A user as used herein may refer to a vehicle operator such as a transportation service provider or a transportation service requestor such as a passenger.

Furthermore, it will be appreciated that reference to service providers herein may include transportation service providers and that reference to users herein may refer to drivers in at least one embodiment.

FIG. 3 provides an example schematic of a signal scanner (i.e., traffic sensor 102) for use with a traffic information system. It will be appreciated that, the scanner may be configured to operate within 0.9 GHz to about 3 GHz with a wavelength of about 3.3 cm. to 10 cm which is the operational range for communication devices such as cellular mobile telephones.

In the example illustrated in FIG. 3, the circuit may use a 0.22 μF disk capacitor, C3 to capture emitted radio frequency (RF) signals from a communication device. In one example, the lead length of the capacitor may be fixed such that the scanner may detect the desired frequency range. It will be appreciated that the disk capacitor along with the lead may act as a gigahertz loop antenna which may collect emitted RF signals from a communication device. An op-amp IC CA3130 (IC1) may be used in the circuit as a circuit-to-voltage converter with capacitor C3 connected between its inverting and non-inverting inputs. This configuration may provide a complimentary MOSFET (CMOS) inverter which may utilize gate protected p-channel MOSFET transistors in the input in order to provide a high input impedance, low input current and high speed performance. The output CMOS transistor may be capable of swinging the output voltage to within 10 mV of either supply voltage terminal in at least one example.

The above described capacitor C3, in conjunction with the lead's inductance, may act as a transmission line that may intercept the signals emitted from communication devices. This capacitor may create a field, store energy, and may transfer the stored energy in the form of finite current to the inputs of IC1. This configuration may affect the balanced input of IC1 and may convert the current into the corresponding output voltage.

As one example, the signal scanner 300 as illustrated in FIG. 3 may be implemented integrally into the real time contextual information collection device 100. As another example, the signal scanner may be coupled to a vehicle such as a vehicle providing transportation services and may be configured to communicate with the traffic information system by way of communicating to the real time contextual information collection device via network connectivity. It will be appreciated that although illustrated in the example figures as a singular unit, the real time contextual information collection device may comprise a plurality of separate components which may be configured to communicate with each other via network connectivity for example.

In some embodiments, a vehicle providing transportation services may further comprise a demand observation system in which data pertinent to a swarm or predicted swarm may be collected. The vehicle thusly may be configured to automatically observe and report swarm conditions to the traffic information system.

For example, a demand observation system described above may be integrated into an existing computational system of an autonomous vehicle or any other type of vehicle comprising a computational system. The demand observation system may comprise a plurality of cameras, sensors, and/or signal scanners configured to collect and transmit data pertinent to traffic condition variability. Such data may include the number of communication devices in a given area, the number of users requesting transportation, the geographical location of a swarm, the time duration of the swarm, the number of users waiting for a ride, and any other information which may be useful to a service provider or the traffic information system.

The demand observation system may, in some examples, additionally be configured to transmit the collected data to the rule driven decision module via the internet, near field communication such as Bluetooth, Wi-Fi, and the like, or any combination thereof. In this way, the data supplied by the demand observation system may be made available to users of the contextual traffic information system in real time as well as providing information relating to predicted future swarms.

Additional examples of demand observation systems may comprise a device or system such as proximity sensors for example, within a vehicle's computer system that may allow for identifying demand and may further notify the traffic information system via communication with the real time contextual information collection device. For example, if a vehicle comprises sensor for detecting proximity of surroundings such as backup or parking sensors, the sensors may be further configured to detect the proximity and/or density of ride requestors at a given location.

A demand observation system may be configured such that the system collects the observed data, transmits the data to the traffic information system via the internet or near field communication for example. The data transmitted to the traffic information system may then be configured for use by users of the traffic information system and may further be made available via a graphical user interface (GUI) of a computing device. In this way, the collected data may then be made available on demand to users of the traffic information system.

One example of a demand observation system may include a visual observation subsystem comprising, for example, one or more cameras that may be configured to observe and collect images pertinent to reported swarms or potential swarms. As an example, a camera system may be coupled to a vehicle or a camera may already be present on the vehicle and may be integrated into the computer system of a vehicle such or an autonomous vehicle. The one or more cameras may then capture images of a swarm or potential swarm and may then transmit the captured images or other useful data to the traffic information system.

Once the data is received by the traffic information system, the information may be analyzed and a notification may then be provided to users of the traffic information system via a GUI for example on a computing device such as a smartphone or other mobile device comprising a graphical user interface.

In one embodiment of a demand observation system, a driver or a transportation service provider may comprise an autonomous vehicle. Said autonomous vehicle may be configured to communicate to the real time contextual information system via communication with the real time contextual information collection device via near field communication methods such as Bluetooth, Wi-Fi, and the like or any combination thereof in order to transmit necessary or pertinent data such as data collected by a visual demand observation system, a computerized demand observation system, or any combination thereof to traffic information system. The data transmitted may then be made available on demand via an online application for example, to users of the traffic information system. In this way, data may be received transmitted, and/or updated in real time.

An exemplary traffic information system may comprise a rule driven decision module configured to enable the real time contextual information collection device to create and/or decimate an event based on a predefined level of conformity to a set of rules and/or criteria defined by a user. The information generated by the rule driven decision module may then be transmitted to a user via a GUI of a communication device to alert the user of a swarm for example. A traffic information system may further comprise a plurality of analytical systems referred to herein as a decision support module which may be configured to enable a user to define strategies and/or criteria of specific events and to transmit the rules and/or criteria to communication devices in a defined geographical boundary or geo fence. The geo fence may then be used by the adaptive decision module which may further be configured to automatically track, calibrate and/or tailor current transportation demand models in order to meet adopted revenue models based on real time actual data that may be gathered from communication devices in the field. Furthermore, the real time decision module may be configured to receive data from the adaptive decision module and further configured to transmit data to the traffic information system.

It will be appreciated that the context and contextual data utilized by the traffic information system may be determined and provided by a user via a web based application and a computing device in at least one embodiment. Contextual data as used herein may refer to any of geographical location, time of day, weather conditions, classification of communication devices detected by the real time contextual information collection device, velocity limit, radius, density, or any other information which may provide additional context relating to a swarm or potential swarm.

With respect to FIG. 4, an example data collection and transmission method performed by an example embodiment of a traffic information system is provided. As an example, a user, such as a transportation provider, may utilize a network connected device 400 to determine and subsequently upload a set of rules and/or other contextual information to the real time contextual information collection device 100 directly as indicated by double ended arrow 404. It will be appreciated that a user may transmit contextual information directly to the registry 201 of the traffic information system, the real time contextual information collection device 100, or may transmit the contextual information to both a registry 201 and the real time contextual information collection device 100 simultaneously. As noted briefly above, a real time contextual information collection device 100 may be coupled to a vehicle 402 such as a transportation service provider vehicle and may communicate to the collective traffic information system via network connectivity in at least one example. However, the real time contextual information collection device may be mounted anywhere that the traffic sensors of the device may detect traffic information. For example, the real time contextual information collection device may be mounted a building, a bicycle, or a lamp post.

In some examples, the real time contextual information collection device may be coupled to a vehicle via a mount. The mount may be a magnetic mount in some examples. In other examples, however, the mount may be a rack that is physically coupled to the vehicle, and the real time contextual information collection device may be physically coupled to the rack. In yet another example, the real time contextual information collection device may be mounted to a dash inside a passenger compartment of a vehicle. The real time contextual information collection device may be mounted wherever the traffic sensor 102 may be able to detect information (e.g., wireless signals). For example, the real time contextual information collection device may be mounted within a passenger compartment of a vehicle or to an exterior of a vehicle.

In an exemplary embodiment wherein a user transmits contextual data directly to the real time contextual information collection device 100, the real time contextual information collection device 100 may then transmit the supplied contextual data to a rule driven decision module 200 as indicated by arrow 406. The rule driven decision module may then utilize one or more of a decision support module, an adaptive decision module, and a real time decision module to aggregate and verify the supplied data. The aggregated data may then be utilized to form a decision such as whether or not to alert a user of a swarm or potential swarm based on the data.

The rule driven decision module 200 may then transmit data pertaining to the type of device or network connectivity of the device 400 used to provide the rules and/or other contextual data to the registry 201, as indicated by arrow 414, of the traffic information system which may then store selected data which may assist the collective traffic information system with identifying or predicting future swarms.

As another example, a user may utilize a network connected communication device 400 to determine and subsequently transmit a set of context based rules or criteria to the traffic information system via the system's registry 201 as indicated by arrow 408. Once the registry 201 receives the data supplied by a user's network connected device 400, the registry may retain and store information relating to the device 400 and the context within one or more of a device registry and an event registry which may comprise the overall registry 201. The registry may then transmit the supplied contextual data to a rule driven decision module 200 of the traffic information system as indicated by arrow 410. The rule driven decision module may then utilize one or more of a decision support module, an adaptive decision module, and a real time decision module to aggregate and verify the supplied data. The aggregated and verified data may then be utilized to form a decision. For example, the aggregated and verified data may be utilized to determine whether or not to alert a transportation service provider of a swarm or potential swarm. The rule driven decision module 200 may then transmit the data, which may include the decision of the rule driven decision module to the real time contextual information collection device 100. Once the real time contextual information collection device receives the contextual information and the decision from the rule driven decision module 200, the device 100 may then utilize a provided traffic information transceiver to transmit an alert to a user's network connected communication device 400 to inform the user of a swarm, potential swarm, or inactive swarm for example.

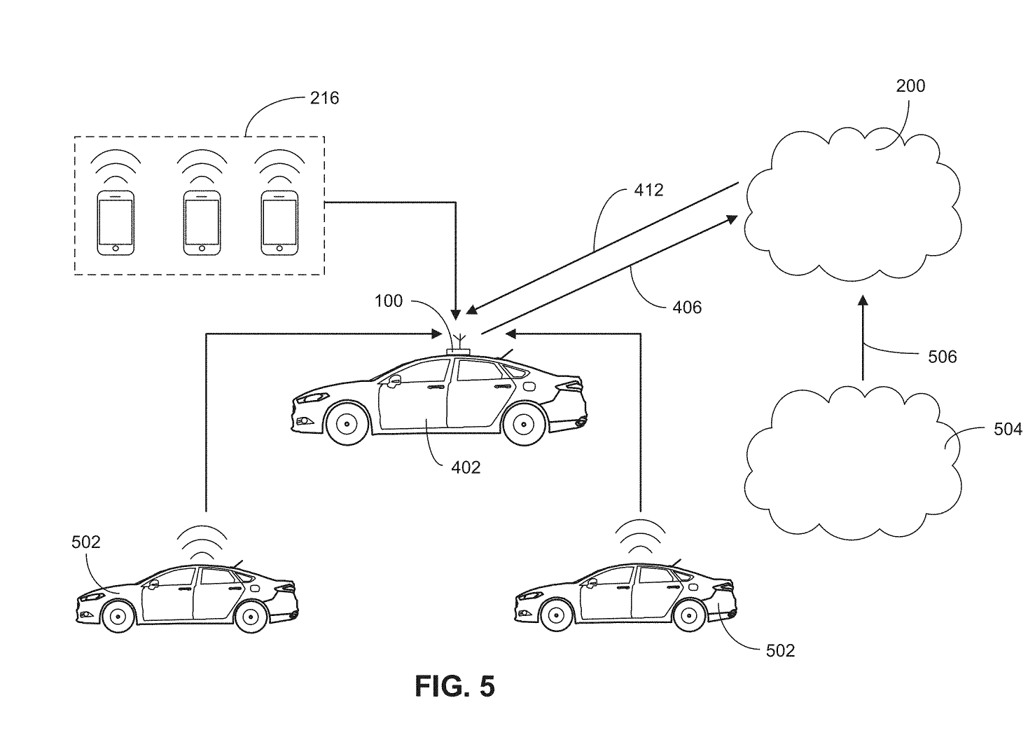

An example passive information collection process as may be executed by a real time contextual information collection device 100 is provided in FIG. 5. In this example, a vehicle of a transportation service provider 402 may be equipped with a real time contextual information collection device which may be physically or otherwise coupled to the vehicle of a service provider 402. However, as discussed above, the real time contextual information collection device may be mounted anywhere that the traffic sensors may be able to detect traffic information (e.g., wireless signals). In exemplary embodiments, the real time contextual information collection device 100 may scan for and subsequently collect wireless signal data from a plurality of sources. For example, the real time contextual information collection device 100 may collect wireless transmission data from a plurality of communication devices 216 such as cellular mobile telephones which may emit wireless signals such as Wi-Fi signals, Bluetooth signals, radio signals, or a combination thereof. The real time contextual information collection device 100 may also scan for and subsequently collect wireless signal data from communication devices associated with or integrated into a secondary real time traffic information source 502.

As used herein, a “secondary real time traffic information source” may comprise a real time contextual information collection device 100 such as described above. It will be appreciated that the data collected from secondary real time traffic information sources may provide insight into traffic density for example, which may be used to determine travel time in at least one example embodiment.

The real time contextual information collection device 100, as noted above, may be configured to communicate to a rule driven decision module 200 which may aggregate and analyze the passively collected wireless signal data and may then pair the data with a set of contextual parameters which may be supplied by a user such as a service provider. The rule driven decision module 200 may additionally source and collect data from sources external of the collective traffic information system such as from third party APIs 504 as indicated by arrow 506.

As one example, the rule driven decision module 200 may source data from a plurality of third party APIs. The real time contextual information collection device may provide data that is at best, real time. Real time data may be useful in some instances, but in the context of supply and demand, often real time data may not be enough. For this reason, it may be desirable to utilize a system which may be capable of providing predictions based on crowd-sourced data or third party APIs. Ideally, users (e.g., service providers) may like to know the precise location of a swarm prior to the increased demand. This may then allow users to travel to the location of a potential swarm or to avoid a swarm. In examples where the user may be a service provider, traveling to the location of a potential swarm prior to the swarm actually occurring may improve profits for the service provider and may potentially alleviate the surge in demand. Though, this particular example utilizes third party data, it is appreciated that in other examples that the traffic may be measured and predicted based only on user collected information such as information collected via real time contextual information collection devices or information reported by users to the traffic information system.

The rule driven decision module 200 may periodically pull event data such as the date, start and end times, location, and anticipated number of attendees for a particular event for example, as well as public transportation schedules, airport schedules, event data from sources such as Facebook or Eventbrite, hotel checkout data, music venues nearby, and more from third party APIs 504 and other publicly available sources. Once the rule driven decision module 200 obtains pertinent data, the rule driven decision module may then use the supplied information 506 to predict where and when an instance of sudden surge in transportation demand may occur. For example, shortly before an even may be scheduled to end, the rule driven decision module may transmit the data 412 to the real time contextual information collection device 100 and the real time contextual information collection device may send a possible swarm alert message over a network to applications or webpages running on a communication device of users for example, which may be within a particular geographical location or geo-fenced map. In this way, users may have access to real time and predictive traffic information. In examples where the users are service providers (e.g., transportation service providers), access to real time and predictive traffic information may improve the overall swing of supply and demand.

Additionally, in some examples, the rule driven decision module 200 may further include a navigation generating engine to generate directions towards or away from measured or predicted traffic. In some examples, the navigation generating engine may determine whether to generate navigational instructions to direct a user towards a region where there is an elevated demand or elevated traffic, or whether to generate navigational instructions to direct a user in such a manner to avoid elevated demand or elevated traffic regions responsive to a user input.

Regions of elevated of human or machine traffic may refer to regions where there is greater than a threshold amount of traffic relative to a base amount of traffic for a particular region. In some examples, the base amount of human traffic and the base amount of machine traffic for a particular region may be based upon a historical average amount of human traffic and machine traffic for a region.

Regarding an elevated demand, an elevated demand may refer to conditions where there is greater than a threshold demand relative to a base demand for a service in a particular region. The base demand for the service may be determined via an average historical demand for the service in a region, for example. In other examples, an elevated demand may be determined responsive to a ratio of service providers to human traffic measured in a region being less than a threshold ratio. In still further examples, an elevated demand may be determined based on user reported information, such as a user verifying that there is an elevated demand for a service in a region.

The user input may be received by a communication device that is connected to the traffic information system via a network. Alternatively or additionally the user input may be received via a display of the real time contextual information collection device. Further, in some examples, such as examples where an autonomous vehicle may be receiving the navigational instructions, the navigation generating engine may determine whether to generate navigational instructions to direct the user (the autonomous vehicle) towards regions where there are elevated demand and/or elevated traffic or whether to direct the user to avoid elevated demand and/or elevated traffic regions based on instructions stored in a computer of the autonomous vehicle. For example, a computer of the autonomous vehicle may include instructions to communicate to with the traffic information system to request to be directed to go towards or to avoid regions of elevated traffic or elevated demand. In some examples, the computer of the autonomous vehicle may include artificial intelligence enabling the autonomous vehicle to communicate with the traffic information system to request to be routed to avoid elevated traffic and elevated demand regions, or to move towards elevated traffic and elevated demand regions.

It will be appreciated that the passive data collection may comprise the collection of wireless signals emitted by one or more communication devices 216, one or more secondary real time traffic information sources 502, and a plurality of third party APIs.

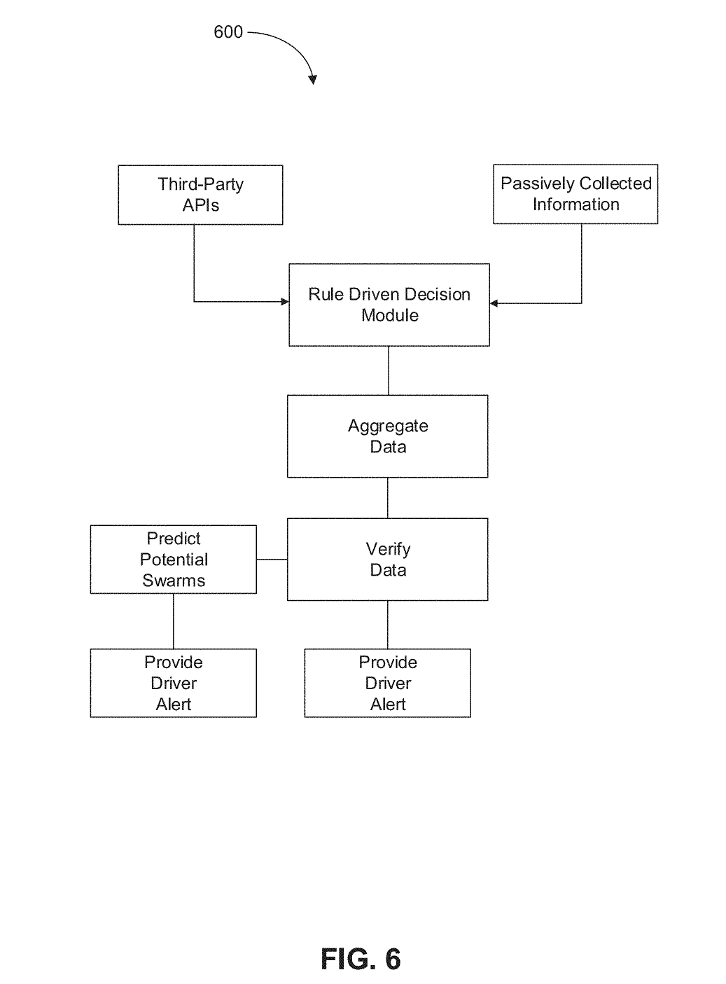

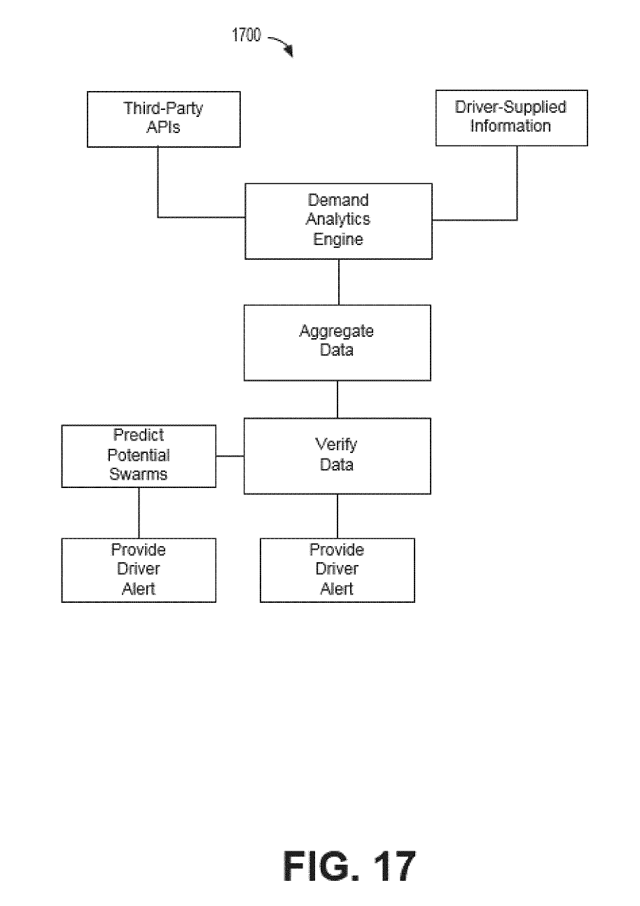

Turning now to FIG. 6, this figure illustrates example processes followed by the traffic information system. Specifically, FIG. 6 demonstrates how the real time contextual information collection device may utilize supplied data in order to provide users with alerts of new swarms, dissipated swarms, and predicted swarms for example. A simplified process performed by the DAE is provided in FIG. 17 Specifically, FIG. 17 demonstrates how a DAE may utilize supplied data in order to provide users with alerts of new swarms, dissipated swarms, and predicted swarms for example. When information is supplied to the demand analytics engine (DAE) either from a user and their associated demand observation system which reports a swarm or via third-party APIs and crowd-sourced data, the DAE may aggregate the supplied data and subsequently verify it. For example, if a user's demand observation system were to report a swarm location, but that same user and their associated demand observation system are not recognized by the DAE as a helpful contributing member of the collective swarm reporting system, the DAE may verify the data provided by waiting for additional incoming data from other alternative users and their associated demand observation systems before producing an alert to other users within the system. As another example, if the DAE receives information from a plurality of third-party APIs, the DAE may then aggregate the data and based on the data supplied for a particular geo-fence, may predict and subsequently alert service providers of the predicted surge in demand.

When information is supplied to the traffic information system via the real time contextual information collection device, either from the passively collected information 604 such as wireless transmission signals emitted from communication devices, third-party APIs 602, or a demand observation system, the real time contextual information collection device may then aggregate the supplied data and subsequently verify it. For example, if the traffic information system were to receive information from a plurality of third-party APIs 602, the system may then aggregate the data and based on the data supplied for a particular geographical radius, herein referred to as a “geo-fence,” the system may then predict and subsequently alert users such as transportation service providers of the predicted surge in transportation demand.

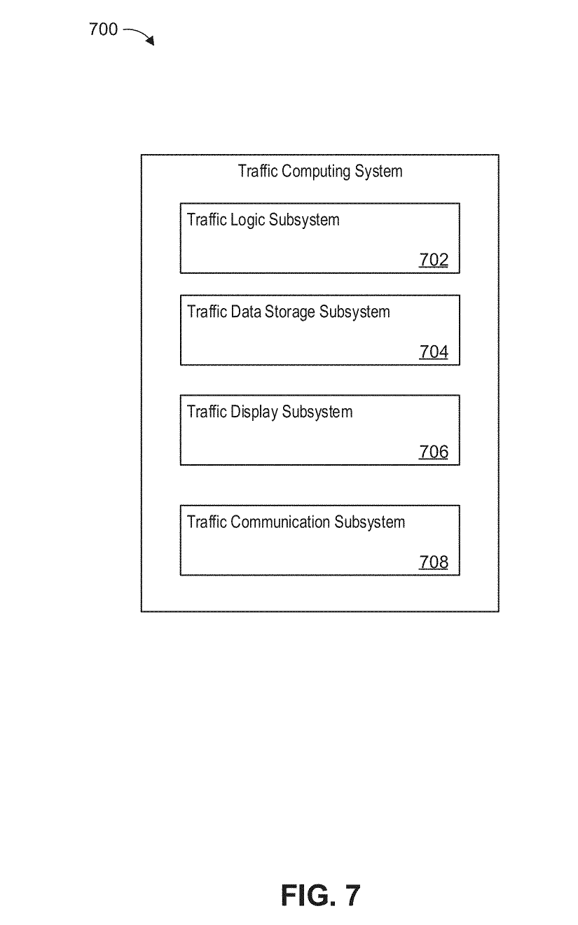

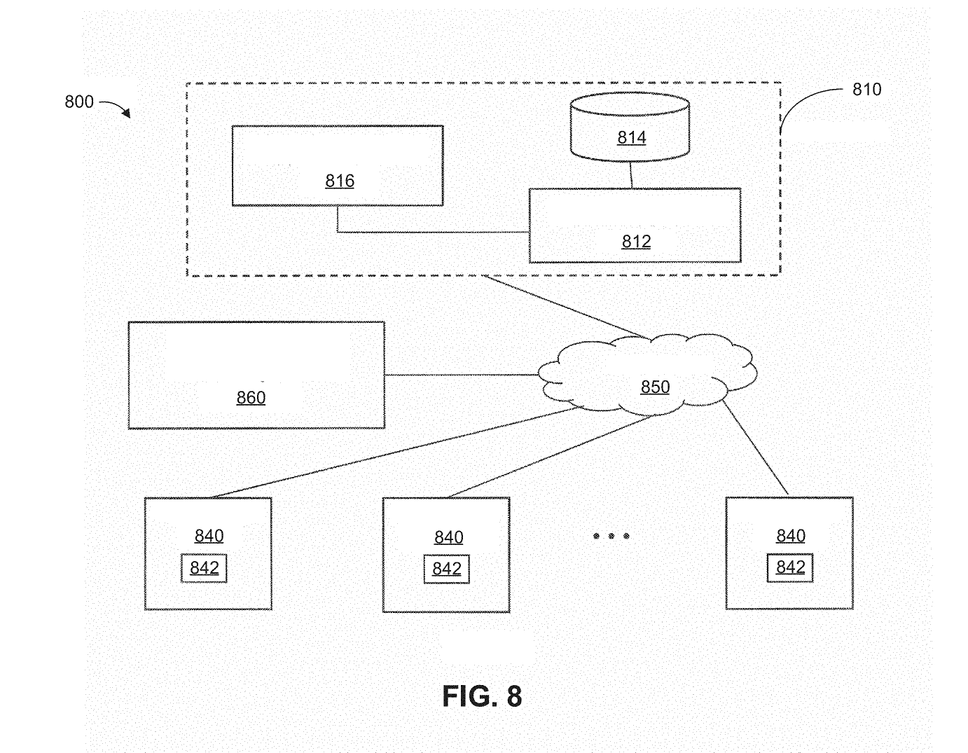

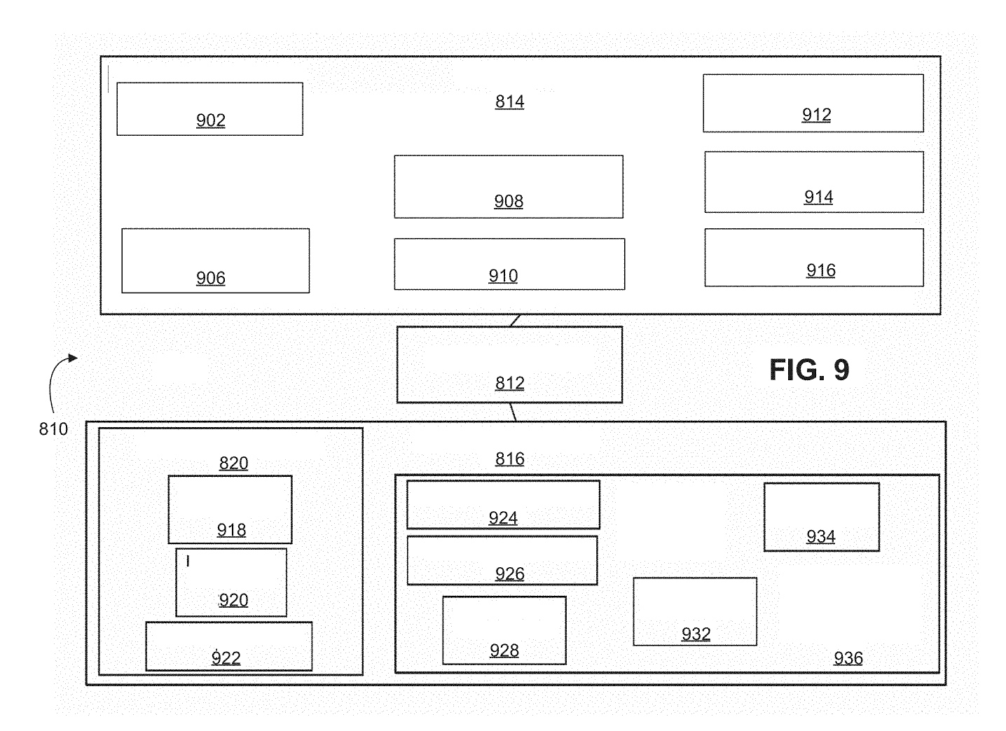

With respect to FIG. 7, this figure provides an example traffic computing system 700 that may comprise the rule driven decision module and the communication devices of the traffic information system's users. The example traffic computing system is described in greater detail below with respect to FIG. 8 and FIG. 9. The example traffic computing systems comprising the traffic information system may comprise a traffic logic subsystem 702, a traffic data storage subsystem 704, a traffic display subsystem 706, and a traffic communication subsystem 708. It will be appreciated that the computing system provided in FIG. 7 may be applicable to both the rule driven decision module and the communication devices of the system's users.

A traffic logic subsystem 702 of an example traffic computing system 700 may be used to interpret data as received by the real time contextual information collection apparatus 100 or a user. The traffic logic subsystem may allow for filtering useful data as obtained from the at least one traffic sensor 102 and/or third party APIs.

The traffic data storage subsystem 704 of the example computing device may be configured such that information may be acquired from the web-based swarm reporting system. In this way, a user such as a transportation provider or driver for example, may be able to store information relevant to a reported swarm or a potential swarm and may then be able to utilize the traffic communication subsystem 708 to receive directions to the reported swarm. A user may then utilize the traffic display subsystem 708 of a communication device such as a smartphone for example, to obtain detailed instructions and directions to respond to a reported swarm.

As noted briefly above, the traffic display subsystem of the computing systems 700 that communicate with the transportation demand system 800 of the traffic information system as illustrated by FIG. 8 do so via a traffic communication subsystem 708. The traffic communication subsystem allows a user such as a transportation provider or driver to view and receive detailed directions relevant to supplying transportation services to the location of a reported swarm.

In the context of the rule driven decision module, the computing system's traffic logic subsystem 702 may collect and aggregate data supplied by one or more of a vehicle's demand observation system, the signal scanner 102 of the information collection apparatus, or third party APIs and crowd-sourced data. The data collected may then be transferred to the traffic data storage subsystem 704 of the computing system 700. In storing collected data, the computing system 700 may provide useful and pertinent data to transportation service providers in anticipation of in response to a surge in transportation demand referred to herein as a swarm. The rule driven decision module's computing system may then utilize a traffic display subsystem 706 to provide a readout of the pertinent data, and may subsequently supply that information to transportation service providers via a traffic communication subsystem.

With regard to the communication devices used by users that are service providers (e.g., transportation service providers), the overall computing system 700 of FIG. 7 may further be applied to the supply and distribution of information relating to surges in demand. For example, the communication device of a user that is a service provider may utilize a traffic communication subsystem 708 of its own to obtain data from the rule driven decision module and may further utilize its own traffic logic subsystem 702 to assess and review the data. The computing system of a communication device such as a smartphone may additionally store the traffic data provided by the rule driven decision module on or in the communication device's traffic data storage subsystem 704. Once information has been stored on the communication device, the device's traffic display subsystem 706 such as the screen of a smartphone for example, may display pertinent information relating to surges in transportation demand.

Referring now to FIG. 8, a schematic diagram illustrating an example of a network architecture used for a traffic information system 800 that may be configured to implement exemplary embodiments of the present disclosure is provided. It should be understood that FIG. 8 is intended as an example, not as an architectural limitation for different embodiments of the present subject matter, and therefore, the specific elements depicted in FIG. 8 should not be considered limiting with respect to the environments within which exemplary embodiments of the present disclosure may be implemented.

In the example illustrated in FIG. 8, a network architecture of a traffic information system 800 may be implemented as a client/server system that includes a central server system 810 that may be commonly accessed by each user of the system through operation of any of a plurality of client systems 840 that may be operatively coupled to the central server system via a communication network 850.

A central server system 810 of the traffic information system 800 may include a database server 812 that may be coupled to a data store 814 and an application server 816. Each client system 840 may comprise a user terminal or other respective client application 842 for accessing services provided via a network based application (also referred to herein as a network service) implemented by application server 816. Such client applications may also be referred to herein as client modules, or simply as clients, and may be implemented in a variety of ways. In exemplary embodiments, such client applications may be implemented as any of a plurality of suitable client application types, which range from proprietary client applications (thick clients) to web-based interfaces in which the user agent function is provided by a web server and/or a back-end program such as a CGI program.

As further illustrated, an example traffic information system 800 may also include at least one third party server system 860 to enable other functionality that may be accessed and utilized by an example server system 810 to provide and/or enhance the network service discussed herein. In exemplary embodiments, traffic information systems 800 may include additional servers, clients, and other devices not shown in FIG. 8. The particular architecture depicted in FIG. 8 is provided as an example for illustrative purposes and, in exemplary embodiments, any number of client systems 840 may be connected to server system 810 at any given time via network 850, and server system 810 may comprise multiple server components and databases located within a single server system or within multiple server systems, where the multiple server systems 840 may comprise a distributed server system via network 850.

In additional example embodiments, network 850 may be configured to facilitate communications between server systems 810 and client systems 840, as well as communications with and between other devices and computers connected together within the transportation demand system 800, by any suitable wired (including optical fiber), wireless technology, or any suitable combination thereof, including but not limited to, personal area networks (PANs), local area networks (LANs), wireless networks, wide-area networks (WANs), the internet (a network of heterogeneous networks using the Internet Protocol, IP), and any virtual private networks. The network may utilize any suitable hardware, software, and/or firmware technology to connect to and communicate with devices such as for example, optical fiber, Ethernet, Integrated Services Digital Network (ISDN), T-1 or T-3 link, Fiber Distributed Data Network (FDDI), cable or wireless LMDS network, wireless LAN, wireless PAN, (for example, IrDA, Bluetooth, wireless USB, Z-wave and ZigBee), Home PNA, power line communication, or telephone line network. Such a network connection may include intranets, extranets, and the Internet; may contain any number of network infrastructure elements including routers, switches, gateways, etc.; may comprise a circuit switched network, such as the global Internet, a private WAN or LAN, a telecommunications network, a broadcast network, or a point-to-point network; and may utilize a variety of networking protocols now available of later developed including, but not limited to the Transmission Control Protocol/Internet Protocol (TCP/IP) suite of protocols for communication.

In exemplary embodiments, application server 816, database server 812, and any other servers employed within server system 810 and third party servers utilized within the transportation demand system 800 may be implemented within any suitable computing system of systems such as workstation computer, a mainframe computer, a server system, a server cluster, a distributed computing system, a cloud based computing system, or the like, as well as any of the various types of computing systems and devices described below with reference to the client systems 840.

Server system 810 may be implemented using any of a variety of architectures. For example, application server 816 and database server 812 may also be implemented independently or as a single, integrated device. While the exemplary embodiment illustrated in FIG. 8 depicts application server 816 and database server 812 as individual components, the applications provided by the server, or various combinations of these applications, may comprise server applications running on separate physical devices. In this regard, server system 810 may comprise a number of computers connected together via a network 650 and, therefore, may exist as multiple separate logical and/or physical units, and/or as multiple servers acting in cooperation or independently, wherein each server may be comprised of multiple separate logical and/or physical units. In exemplary embodiments, server system 810 may be connected to a network 850 through a collection of suitable security appliances, which may be implemented in hardware, software, or a combination thereof.

As shown in FIG. 8, application server 816 may be communicatively coupled to database server 812. Database server 812 may be connected to a data store 814, which may comprise a plurality of databases that may be maintained by database server 612, and store information on a variety of matters that may be utilized in providing the services offered via the network service provided by the application server as described below in greater detail. It will be understood that the term “data store,” “data storage unit,” “storage device,” and the like as used herein, refer to any suitable memory device that may be used for storing data, including manual files, machine-readable files, and databases. In exemplary embodiments, application server 816, database server 812, and data store 814 may be implemented together or as a single computing device, implemented within a plurality of computing devices locally coupled to each other via suitable communication medium, such as a serial port cable, telephone line, or wireless frequency transceiver, implemented within a plurality of computing devices remotely coupled to each other via a network 850, or any suitable combination thereof.

Client systems 840 may comprise computer devices to which one or more users, which may be transportation providers or dispatch services for example, have access. It should be understood that the term “user” as used herein refers to one who uses a computer system, such as one client system 840 which may be operable by such users to access server system 810 via network 850 and act as clients to access services offered by the transportation demand system. For this purpose, each client system may include a respective client application 842 that executes on the client system and may allow a user to interact with server system 810 via application server 816.

FIG. 9 further illustrates an exemplary embodiment of a server system 810 inclusive of a data store 814 which may comprise plurality of databases that may be maintained and may be accessible by application server 816 via database server 612, including a service provider database 902, a provider affiliation database 906, an available services database 908, a swarm information database 910, a swarm prediction database 912, a geo-fence database 914, and one or more additional databases 916 that may be used for storing any other suitable information that may be utilized by the server system 810. For example, the additional databases 916 may comprise system usage data, audit trail data, data used internally within the system by application server 816, and the like.

In one example, the various databases maintained within the data store 814 may be maintained as groups within one or more larger databases or may be maintained individually. For example, service provider database 902, provider affiliation database 906, swarm information database 910, and a geo-fence data base 914 may be maintained as a single group within a general profile database that may be maintained within the data store 814.

The application server 816 may be configured to maintain various types of records and information within the plurality of databases. An information record may comprise, for example, a program and/or data structure that may track the various data related to a corresponding type of information record. As used herein, the terms “data,” “content,” “information,” and similar terms may be used interchangeably in order to refer to data capable of being captured, transmitted, received, displayed, and/or stored in accordance with various example embodiments provided herein. Thus, the use of any such terms should not be taken to limit the scope or nature of this disclosure. Further, where a computing or communication devices is described herein to receive data from another computing or communication device, it will be appreciated that the data may be received directly from another computing device or may be received indirectly via one or more intermediary computing devices, such as, for example, one or more servers, relays, routers, network access points, base stations, and/or the like. Similarly, where a computing or communication device is described herein to send data to another computing or communication device, it will be appreciated that the data may be sent directly or indirectly to another computing or communication device or may be sent directly or indirectly to another computing or communication device or may be sent indirectly via one or more intermediary computing or communication devices such as one or more servers, relays, routers, network access points, base stations, and/or the like.

Application server 816 may further be configured to maintain and manage account information records for a variety of types of users that may register with the system according to certain categories of accounts. In the present example embodiment, service provider database 902 may be used to maintain account information records for transportation service providers that register with the server system 810 to provide contextual information to the traffic information system. For each service provider and an optional demand observation system for which an account is registered with server system 810, various pieces of information relevant to the service provider and an optional demand observation system, such as user name, current location, typical routes, and any other suitable identifying information as well as a unique username and password associated with the account that may be used to log into the account may be included in the respective account information record for the transportation service provider and their optionally associated demand observation system that may be maintained within the service provider database 902. The account information record for each service provider may also be associated with a unique user account identifier within the service provider database 902 that may be used by the application server 816 to perform various operations.

The provider affiliation database 906 of the data store 814 of server system 810 may be configured to maintain records of service providers and their optionally associated demand observation systems within the traffic information system to recognize the affiliation of the service providers. For each affiliation group for which an account may be registered with server system 810, various items of information relevant to the service provider such as company name, area serviced, number of users, and any other suitable information relevant to service providers may be stored. Each affiliation group may also be assigned a unique identifier to be maintained within the provider affiliation database 906.

Another example feature of data store 814 is the available services database 908, which may be used to maintain information record pertinent to the services offered by traffic information system. In exemplary embodiments, the respective information for swarm identifying services which may be maintained in the available services database 908 and the information that populates the respective information record for each service may be created and maintained by a back-end administrator of server system 810. For each service for which an information record is created, various items of information relevant to the service may be maintained within the available services database 908.

Additionally, in some example embodiments, a swarm information database 910 may be provided. The swarm information database 910 may be used to maintain records pertinent to a swarm or potential swarm identified or predicted by the traffic information system. In this example embodiment, the respective information for swarms, including swarm location, swarm duration, and any other suitable information may be maintained by the swarm information database 910. For each service for which an information record is created, various items of information relevant to the swarm or predicted swarm may be maintained within the swarm information database. It will be appreciated that the swarm information database 910 may provide information that may help predict future swarms.

The data store 814 provided in FIG. 9 may also comprise a swarm prediction database 912. The swarm prediction database may be used to maintain records relevant to past swarms, current crowd sourced data (such as public transportation arrival times, venue closing times, etc.), data sourced from third party APIs, and any other pertinent information may be stored within the swarm prediction database. The information provided to a transportation service provider via the swarm prediction database may be created and maintained by a back-end system administrator.

A geo-fence database 914 may also be provided in exemplary embodiments in which information relevant to the supply of transportation providers and demand for transportation may be stored. The geo-fence database 914 of the data store 814 may be inclusive of information such as, for example, the number of transportation service providers within a given area, estimated arrival times to a swarm or potential swarm, and any other information relevant to the location of a swarm or reported swarm and the availability of transportation service providers to respond to a swarm or reported swarm.

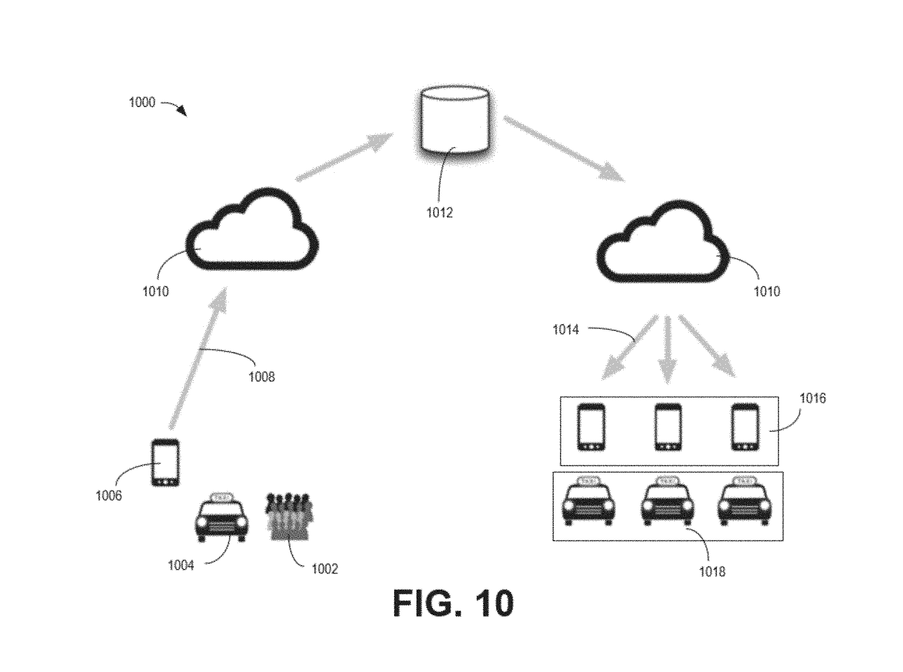

Turning now to FIG. 10, this figure illustrates an example of a swarm reporting phase 1000 which may be carried out by the traffic information system.

Some example methods for collecting real time contextual information about human and machine traffic may include a “swarm reporting” phase. This swarm reporting phase may be a first step in some example methods. In some examples, this swarm reporting phase may relate to a transportation service provider such as a taxi operator reporting the location of a particular instance of transportation demand surge via a demand observation system. For example, a transportation provider may be able to report a surge in ride demand near the end of an event such as a concert or convention where attendees may face a shortage of available transportation providers in a particular area. Once the swarm has been reported, other providers (e.g., vehicle operators) in the vicinity may be alerted to this surge and may be provided with the geographical coordinates and/or directions to the reported swarm location. Using this information, other providers may subsequently be able to travel to the swarm location, thus increasing the available supply of transportation vehicles.

The swarm may be considered an elevated demand for service providers to “swarm” to a location of increased demand. The elevated demand may be a substantial increase relative to the base demand of a particular region. In other examples, the swarm may be considered a region of elevated human and/or machine traffic.

The swarm reporting phase 1000 may begin with a sudden surge in demand 1002 (e.g., transportation demand). In some examples, a surge in demand may be due to an event that may impact an amount of one or more of human traffic and machine traffic, such as an ending of a concert. Once the surge in demand 1002 has been recognized, a reporting user 1004 may then recognize via a demand observation system that there is a large demand 1002 for service, in this example transportation, that may be unaddressed.

The reporting user in this example may refer to a vehicle operator that utilizes a demand observation system to report swarms to the swarm reporting system. The demand observation system may then utilize an application or a website on a user's mobile device 1006 in order to report an instance of a swarm. This process may be considered as a swarm report 1008. In some examples, the swarm report 1008 may include the geographical location of the reporting user 1004, the geographic location of the reported swarm, a timestamp of the report, a unique identifier for the reporting user 1004, and any additional pertinent information from the reporting user 1004 and/or the demand observation system about the ride demand 1002. The swarm report 1008 may then be transmitted over a network such as the internet 1010 to a Demand Analytics Engine (DAE) 1012. In some examples, the DAE may be a part of the rule driven module, as described above. The DAE 1012 may then examine the swarm report, evaluate the history of the reporting user 1004 and the associated demand observation system and may determine a relative priority of the report based on the history of that particular reporting user 1004 and the associated demand observation system. Based on this priority, the DAE may send a geo-fenced alert 1014 over the internet 1010 to applications on the mobile devices 1016 of other service providers 1018 (e.g., transportation providers) in the area of the geo-fence. In other words, other service providers 1018 that are within a certain predetermined distance from the surge or the swarm report may be alerted via an application on their mobile device 1016 interfaces. The alert 1014 may include information such as a timestamp of the report, the geographical location of the swarm, and other pertinent information.

Higher priority reports relative to other swarm reports may then have a larger geographical region, or geo-fence, in which other service providers 1018 may be notified. For example, a low priority report may have a geo-fence radius of half a mile, whereas a high priority report may have a geo-fence radius of over a mile. Other service providers 1018 that may be located outside of the geo-fenced alert may still have access to the alert and may still learn about the swarm through a “heat-map” of the overall area. The heat-map may aggregate all of the received swarm reports within a metropolitan area in order to provide a high level overview of the current demand for transportation.

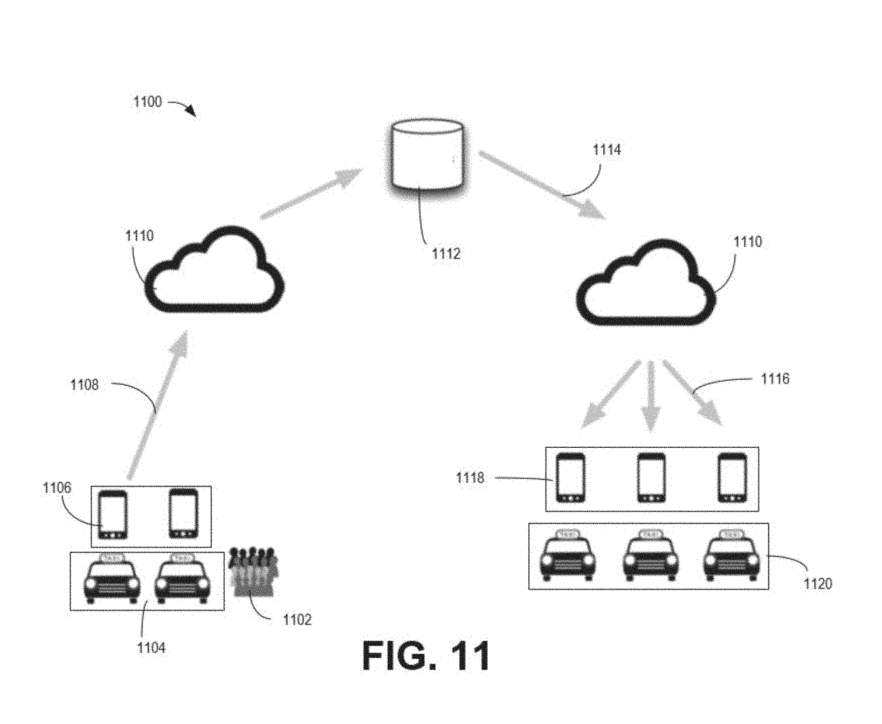

Turning now to FIG. 11, an example swarm confirmation phase is illustrated. Some example methods for collecting real time contextual information about human and machine traffic may include a swarm confirmation phase. The swarm confirmation phase may be a phase immediately following a swarm reporting phase, in some examples. In methods where a swarm reporting phase may be a first phase, a swarm confirmation phase may be a second phase. However, other orders may be possible. In the swarm confirmation phase, a similar top-level process flow to the swarm reporting phase may be utilized. As verifying service providers 1104 such as transportation providers arrive at the location of a reported swarm 1102, a website or an application running on the verifying users mobile devices 1106 may pop up and alert the user of a request to verify the swarm 1102. If one of a plurality of verifying service providers 1104 or their associated demand observation systems notices that an elevated ride demand 1102 may still exist, then a verifying service provider 1104 has the option to send a swarm confirmation 1108 via the associated demand observation system over the internet 1110 to the DAE 1112. The swarm confirmation message 1114 may then be sent over the internet 1110 and may be stored for use when other service providers travel into the geo-fence of the swarm confirmation for example. The swarm confirmation message 1114 may include a unique identifier of the verifying service provider 1104 and their demand observation system, a timestamp of the confirmation, a unique identifier for the reported swarm 1102, and any additional pertinent information regarding the swarm. The DAE 1112 may function to receive the swarm confirmation 1108 and analyze the data provided. If the verifying service provider 1104 is recognized by the DAE 1112 as a helpful and contributing member of the swarm reporting system 1100, then the DAE 1112 may immediately increase the priority of the swarm report. However, if the verifying service provider 1104 is recognized as a non-helpful member of the swarm reporting system, or if the verifying service provider 1104 is new to the system, the DAE 1112 may wait for additional swarm confirmations 1108 from other service providers or demand observation systems before issuing a confirmation message 1116.

Based on the incoming confirmations 1108, the DAE 1112 may raise the priority of the swarm 1102 which may then increase the radius of a geo-fenced alert. In this way, an alert 1116 may be sent to applications or webpages running on the mobile devices 1118 of other service providers 1120. By doing this, other service providers 1120 may be encouraged to travel to the location of the sudden surge in demand. In other words, potential customers within the reported swarm 1102 (inclusive of those who have not yet requested a service) may have a multitude of service providers as options. Service providers 1104, 1120 may benefit from this method due to the potential for service providers to acquire customers from a swarm 1102. For example, transportation providers may benefit by being able to acquire customers from a swarm 1102 rather than just driving around waiting for a fare.

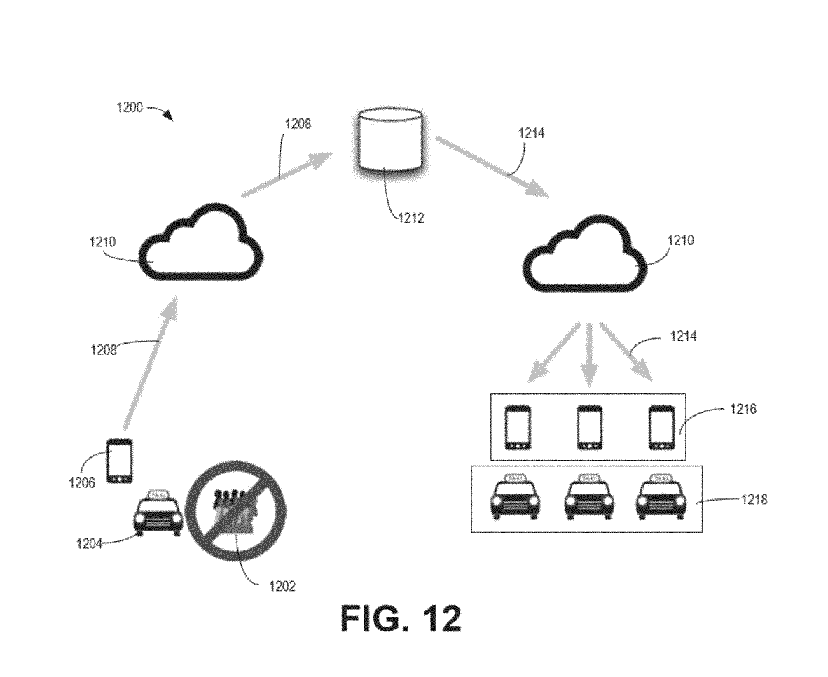

Turning now to FIG. 12, an example swarm dissipation phase is illustrated. Some embodiments for collecting real time contextual information about human and machine traffic may include a swarm dissipation phase. The swarm dissipation phase may relate generally to reporting that a swarm has dissipated or is no longer active. This swarm dissipation phase may be similar to the swarm confirmation phase except that the end result of this phase is opposite that of the confirmation phase. Specifically, as verifying service providers 1204 (e.g., transportation service providers) start to arrive at the location of a reported swarm 1202, a website or application running on the verifying service provider's 1204 mobile device 1206, may pop up and request verification of the swarm 1202. If the verifying service provider 1204 and their associated demand observation system do not perceive an elevated demand 1202 (e.g., demand for transportation), then the verifying service provider's 1204 demand observation system may send a swarm dissipation message 1208 over the internet 1210 to be received by the DAE 1212. The swarm confirmation message may include a unique identifier for the verifying service provider 1204 and their associated demand observation system, a timestamp of when the swarm 1202 was reported, a unique identifier for the reported swarm 1202, and any other additional pertinent information regarding the swarm 1202. Further, the DAE 1212 may receive the swarm confirmation 1208 and analyze the data it provides. If the verifying service provider 1204 and their associated demand observation system is recognized by the DAE 1212 as a helpful member of the swarm reporting system 1200, then the DAE 1212 may automatically and immediately lower the priority of the reported swarm 1202. However, if the verifying service provider 1204 and their associated demand observation system is not recognized as a helpful member of the swarm reporting system, or if the service provider 1204 and their associated demand observation system is new, the DAE 1212 may wait for additional swarm confirmations 1208 from other demand observation systems before issuing a dissipation alert 1214 over the internet 1210 to applications or webpages on the mobile devices 1216 of other service providers 1218.

Based on the incoming swarm confirmations 1208, the DAE 1212 may increase or decrease the priority of the reported swarm 1202 which may then result in an increase or decrease in the radius of a geo-fenced alert provided by the collective swarm reporting system and the DAE 1212. In this way, additional service providers may be discouraged from traveling to the location of a swarm 1202 that may no longer exist, or a swarm that has dissipated. This may allow service providers to focus their efforts on areas of a higher priority without wasting valuable time or fuel while waiting for a fare.

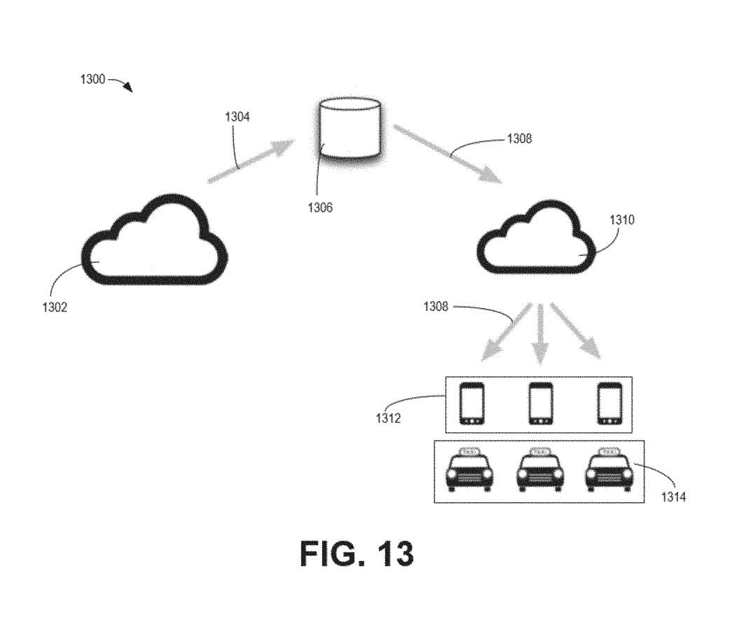

The description above may further include additional embodiments of a collective swarm reporting system in which the data provided to a DAE 1306 is supplied via third party sources such as third party application program interfaces (APIs) 1302. This method of supplying information to the DAE 1306 may not rely on users or their demand observation systems to report swarms. Rather, it may allow for a prediction of where and when a potential swarm may occur. This method is illustrated in FIG. 13.

While the most verifiable data source may be information obtained directly from users and their associated demand observation systems, this data is at best, real-time. Real-time data may be useful in some instances, but in the context of supply and demand, often real-time data is not enough. For this reason, it may be desirable to utilize a program that may be capable of providing predictions based on crowd-sourced data. Ideally, service providers would like to know the precise location of a swarm prior to the increased demand. This may allow service providers to get a head start on traveling to a potential swarm location and may further improve profits made by the service provider as well as alleviating the surge to a certain extent. This particular instance is where publicly sourced and third-party data comes into play. The DAE 1306 may periodically pull event data such as the date, start and end times, location, and anticipated number of attendees for a particular event as well as public transportation schedules, airport schedules, event data from sources such as Facebook or Eventbrite, hotel checkout data, music venues nearby and more from third-party APIs 1302 and other public sources. Once the DAE 1306 has obtained pertinent information 1304, it may use the supplied information 1304 to predict where and when there may be sudden surges in demand (e.g., transportation demand). For example, shortly before an event is scheduled to end, the DAE 1306 may send a possible swarm message 1308 over the internet 1310 to applications or webpages running on the mobile devices 1312 of users 1314 that are within a particular geo-fenced map. As users 1314 arrive in the vicinity of a predicted swarm, they may then report a swarm via their demand observation system which may then bootstrap the rest of the aforementioned swarm process.

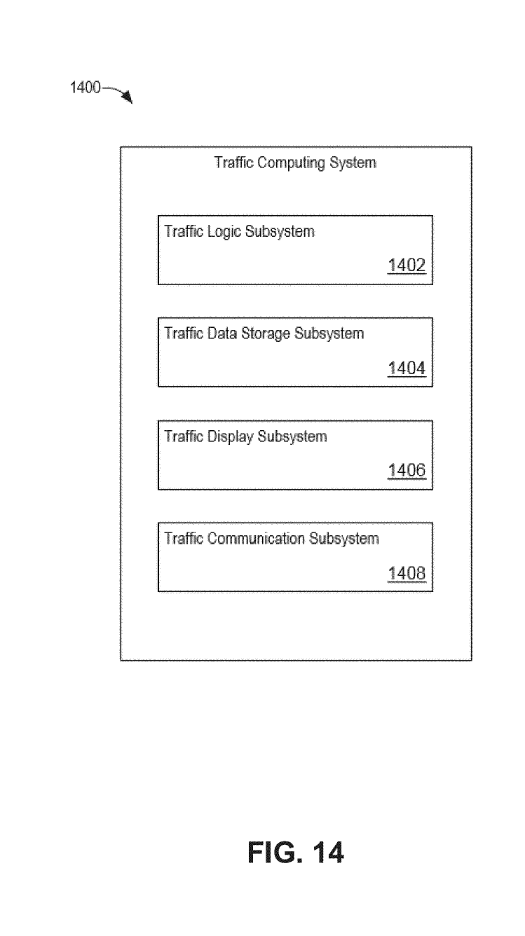

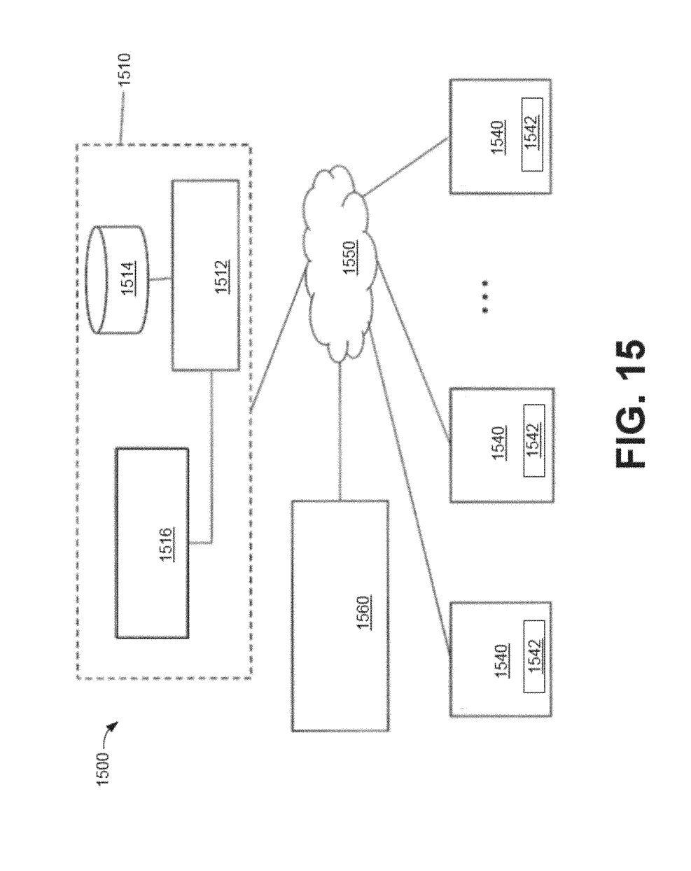

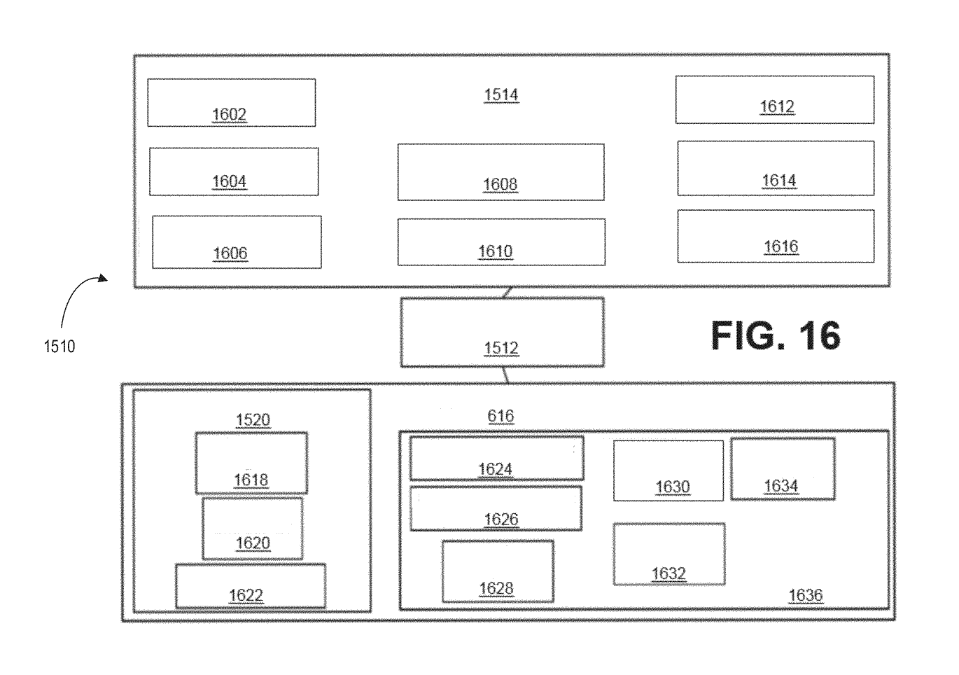

Turning now to FIG. 14, this figure shows an example general computing system very similar to FIG. 7 that may comprise the Demand Analytics Engine and the mobile devices of the system's users. The example computing system is described in greater detail below with respect to FIG. 15 and FIG. 16. The example computing systems used in the collective swarm reporting system may further comprise a traffic logic subsystem 1402, a traffic data storage subsystem 1404, a traffic display subsystem 1406, and a traffic communication subsystem 1408. It will be appreciated that the computing system provided in FIG. 14 may be applicable to both the DAE as described above, and the mobile devices of the system's users.

A traffic logic subsystem 1402 of an example computing system 1400 may be used to interpret data as received by an end user or an administrator. The traffic logic subsystem may allow for filtering useful data as obtained from third-party APIs or untrusted users within the collective swarm reporting system.

The traffic data storage subsystem 1404 of the example computing device may be configured such that information acquired from the web-based swarm reporting system. In this way, an end user, for example, a member user, such as a driver that is a user of the collective swarm reporting system, may be able to store information relevant to a reported swarm and may then utilize the traffic communication subsystem 1408 to receive directions to the reported swarm and may then utilize the traffic display subsystem of, for example, a mobile device in order to be provided with detailed instructions and directions to respond to a reported surge in demand (e.g., demand for transportation). It should be appreciated that a member service provider may refer to a recognized user of the collective swarm reporting system.

The traffic display subsystem of the computing systems 1400 that communicates with the traffic information system 1600 via a traffic communication subsystem may provide an end user (e.g., a member driver) the opportunity to view and receive detailed directions relevant to supplying service resources to a reported swarm. The computing subsystem 1400 and its respective components are described in much greater detail below with respect to FIG. 15 and FIG. 16.

In the context of the DAE, the computing system's traffic logic subsystem 1402 may collect and aggregate data supplied either by users and their associated demand observation systems or third-party APIs and crowd-sourced data. The data collected may then be transferred to the traffic data storage subsystem 1404 of the computing system 1400. In storing collected data, the computing system 1400 may provide useful and pertinent data to users in anticipation or in response to a surge in service demand referred to as a swarm. The DAE's computing system may then utilize a traffic display subsystem 1406 to provide readout of the pertinent data, and subsequently supply that information to the users via a traffic communication subsystem 508.

With regard to the mobile devices used by the service providers, the overall traffic computing system 1400 of FIG. 14 may further be applied to the supply and distribution of information relating to surges in service demand (e.g., transportation demand). For example, the mobile device of a user may use a traffic communication subsystem 1408 of its own to obtain data from the DAE and may further utilize its own traffic logic subsystem 1402 to assess and review the data. The computing system of a mobile device may additionally store the data provided by the DAE on or in the mobile device's traffic data storage subsystem 1404. Once information has been stored on the mobile device, the device's traffic display subsystem such as the screen of a phone for example, may display pertinent information relating to surges in service demand.

Referring now to FIG. 15, a schematic diagram illustrating an example of a network architecture used for a traffic information system 1500 that can be configured to implement exemplary embodiments of the present invention is provided. It should be understood that FIG. 15 is intended as an example, not as an architectural limitation for different embodiments of the present subject matter, and therefore, the particular elements depicted in FIG. 15 should not be considered limiting with regard to the environments within which exemplary embodiments of the present disclosure may be implemented. The example network architecture illustrated at FIG. 15 is very similar to the network architecture illustrated at FIG. 8

In the example illustrated in FIG. 15, traffic information system 1500 is implemented as a client/server system that includes a central server system 1510 that is commonly accessed by each user of the system through operation of any of a plurality of client systems 1540 that are operatively coupled to the central server system via a communication network 1550. Central server system 1510 further includes a database server 1512 that is coupled to a data store 1514 and an application server 1516, and each client system 1540 is a user terminal or other respective client application 1542 for accessing services provided via a network-based application (also referred to herein as a network service) implemented by application server 1516. Such client application may also be referred to as client modules, or simply clients, and may be implemented in a variety of ways. In exemplary embodiments, such client applications may be implemented as any of a plurality of suitable client application types, which range from proprietary client applications (thick clients) to web-based interfaces in which the user agent function is provided by a web server and/or a back-end program such as a CGI program.

As further illustrated, an example traffic information system 1500 may also include at least one third-party server system 1560 to enable other functionality that may be accessed and utilized by an example server system 1510 to provide and/or enhance the network service discussed herein. In exemplary embodiments, traffic information systems 1500 may include additional servers, clients, and other devices not shown in FIG. 15. The particular architecture depicted in FIG. 15 is provided as an example for illustrative purposes and, in exemplary embodiments, any number of client systems 1540 may be connected to server system 1510 at any given time via network 1550, and server system 1510 may comprise multiple server components and databases located within a single server system or within multiple server systems, where the multiple server systems 1540 as a distributed server system via network 1550.

In additional example embodiments, network 1550 can be configured to facilitate communications between server system 1510 and client systems 1540, as well as communications with and between other devices and computers connected together within traffic information system 1500, by any suitable wired (including optical fiber), wireless technology, or any suitable combination thereof, including, but not limited to personal area networks (PANs), local area networks (LANs), wireless networks, wide-area networks (WANs), the internet (a network of heterogeneous networks using the Internet Protocol, IP), and any virtual private networks, and the network may also utilize any suitable hardware, software, and firmware technology to connect devices such as, for example, optical fiber, Ethernet, ISDN (Integrated Services Digital Network), T-1 or T-3 link, FDDI (Fiber Distributed Data Network), cable or wireless LMDS network, wireless LAN, wireless Pan (for example, IrDA, Bluetooth, wireless USB, Z-Wave and ZigBee), HomePNA, Power line communication, or telephone line network. Such a network connection may include intranets, extranets, and the Internet, may contain any number of network infrastructure elements including routers, switches, gateways, etc., may comprise a circuit switched network, such as the Public Service Telephone Network (PSTN), a packet switched network, such as the global Internet, a private WAN or LAN, a telecommunications network, a broadcast network, or a point-to-point network, and may utilize a variety of networking protocols now available or later developed including, but not limited to the Transmission Control Protocol/Internet Protocol (TCP/IP) suite of protocols for communication.

In exemplary embodiments, application server 1516, database server 1512, and any other servers employed within server system 1510 and third-party servers utilized within traffic information system 1500 may be implemented within any suitable computing system or systems such as a workstation computer, a mainframe computer, a server system, a server cluster, a distributed computing system, a cloud based computing system, or the like, as well as any of the various types of computing systems and devices described below with reference to the client systems 1540. Server system 1510 may be implemented using any of a variety of architectures. For example, application server 1516 and database server 1512 may also be implemented independently or as a single, integrated device. While the exemplary embodiment illustrated in FIG. 15 depicts application server 1516 and database server 1512 as individual components, the applications provided by these servers, or various combinations of these applications, may comprise server applications running on separate physical devices. In this regard, server system 1510 may comprise a number of computers connected together via a network 1550 and, therefore, may exist as multiple separate logical and/or physical units, and/or as multiple servers acting in cooperation or independently, wherein each server may be comprised of multiple separate logical and/or physical units. In exemplary embodiments, server system 1510 may be connected to a network 1550 through a collection of suitable security appliances, which may be implemented in hardware, software, or a combination thereof.

As shown in FIG. 15, application server 1516 is communicatively coupled to database server 1512. Database server 1512 is connected to a data store 1514, which comprises a plurality of databases that may be maintained by database server 1512, and store information on a variety of matters that is utilized in providing the services offered via the network service provided by the application server as described below in greater detail. It will be understood that the term “data store,” “data storage unit,” “storage device,” and the like as used herein refer to any suitable memory device that may be used for storing data, including manual files, machine-readable files, and databases. In exemplary embodiments, application server 1516, database server 1512, and data store 1514 may be implemented together or as a single computing device, implemented within a plurality of computing devices locally coupled to each other via suitable communication medium, such as a serial port cable, telephone line or wireless frequency transceiver, implemented within a plurality of computing devices remotely coupled to each other via a network 1550, or any suitable combination thereof.

Client systems 1540 may comprise computer devices to which one or more users, which may be transportation providers or dispatch services for example, have access. It should be understood that the term “user” as used herein refers to one who uses a computer system, such as one of client system 1540 are each operable by such users to access server system 1510 via network 1550 and act as clients to access services offered by the traffic information service 1500. For this purpose, each client system may include a respective client application 1542 that executes on the client system and may allow a user to interact with server system 1510 via application server 1516.

An example embodiment of the present subject matter may provide that the computer systems of client systems 1540 may be any of a wide range of suitable computing devices such as one or more workstations, desktop computers, laptops, or other personal computers (PCs), non-traditional-computer devices such as mobile devices and other suitable handheld or portable electronic device, smart phones, and other mobile handsets, tablet computers, netbook computers, game consoles, home theater PCs, desktop replacement computers, and the like, or any other suitable information processing devices. An exemplary computer system for client systems 1540 is described in greater detail below with reference to FIG. 16.

During operation of an exemplary traffic information system 1500, a client system 1540 may first establish a connection to server system 1510 via a network 1550. Once the connection has been established, the connected client system may directly or indirectly transmit data to and access content from the application server 1516. A user accessing application server 1516 through the connected client system may then thereby use a client application 1542 in order to access services provided by the application server via a user interface implemented by the client application within which the client application renders the information served by the application server.

In one example, application server 1516 may implement network service as a non-web client application (such as a mobile application), a web client application, or a combination thereof in order to provide the services accessed by client systems 1540 within server system 1510, and client applications 1542 may correspondingly be implemented as non-web client applications, web client applications, or a combination thereof for operation by users of the client systems as a way to interact with application server 1516 and access the services provided thereby. For example, the application server 1516 may comprise a web server configured to provide a web application for the respective client applications implemented on client systems 1540 that are configured to provide web-based user interfaces for utilizing the services provided by the web server. For example, the user interface of client applications implemented on client systems 1540 may be configured to provide various options corresponding to the functionality offered in example embodiments described herein through any of a plurality of suitable user interface controls, for example, by way of menu selection, point-and-click, dialog box, or keyboard commands. In one general example embodiment, the user interfaces may provide “send” or “submit” buttons that may allow users of client applications to transmit requested information to application server 1516. The user interfaces can be implemented, for instance, as a graphical user interface (GUI) that renders a common display structure to represent the network service provided by application server 1516 for a user of a client platform.

More specifically, in such an embodiment, application server 1516 may be configured to provide services via a web-based software application hosting a corresponding website that includes a number of web pages or screens, and client applications 1542 may comprise a web browser executing on client systems 1540 such that the services provided by application server 1516 are accessible to client systems 1514 using the Internet or an intranet. Users of client systems 1540 may then thereby access the website provided by application server 1516 by, for example, inputting or following a link to the uniform resource locator (URL) of the website in the web browser, which may then enable users to display and interact with information, media, and other content embedded within the web pages of the website provided by application server 1516. The web-based software application may be configured to transmit information that can be processed by the web browsers to render a user interface using, for example, a browser-supported programming language such as JavaScript, HTML, HTML5, and CSS or the like, and may communicate with the web browsers using, for example, HTTPS, POST, PUT and/or GET requests. Client applications 1542 and application server 1516 may further be configured such that information transmitted between client systems 1540 and server system 1510 may be encrypted and sent over a secure network connection to protect for example, user privacy.

Turning now to FIG. 16, a block diagram illustrating an exemplary embodiment of a server system 1510 is shown. The exemplary server system illustrated at FIG. 16 is very similar to the example server system illustrated at FIG. 9. As illustrated in FIG. 16, application server 1516 is implemented to provide a plurality of services via a member user portal 1520 and a plurality of services via a swarm reporting portal 1636. As described herein, application server 1516 may be implemented to provide a respective set of services for each of various types of users (for example, unregistered guests, member users, service provider company administrators, service dispatch providers, system administrators, and the like), and some of the services offered by application server 1516 may be commonly applicable to and accessible by all types of users, while other services may only be applicable to and accessible to or by specific types of users. For purposes of description, the terms “providers” and “provider users” are used herein to refer to the general class of users that register with the system to offer demand predicting services (e.g., transportation demand predicting services), which can include member users, dispatch services, and the like. As an example, an account established for a transportation service may include a driver may as one of its member users. The account may also have dispatchers or other service provider staff as authorized users. For example, in the case of a transportation service, the dispatchers may be transportation dispatchers and the authorized users may be authorized drivers. The authorized users may then be able to log into the account and perform various actions with the permission of the member user. In this way, a single service provider or dispatch service may establish a single account. For purposes of illustration, there can be a designated user (for example, an account administrator) who is responsible for managing the account. The administrator may then be provided with greater access rights within server system 1510 with respect to the account. One example embodiment provides that particular client applications 1542 or particular client systems 1540 that are utilized for accessing application server 1516 can be respective to and customized for each type of user account. For example, the particular client application that is utilized for each type of account may be implemented to provide a virtual computing platform that may be specific to the services offered to that type of account.

As further illustrated in the example embodiment of FIG. 16, and as will be described in greater detail below, the services provided via member user portal 1520 include a registration and account management service 1618, a navigation and search service 1620, and a swarm reporting service 1622. The services provided via the swarm reporting portal 1636 may include a registration and account management service 1624, a user affiliation management service 1632, a service management service 1626, a swarm management service 1628, a swarm confirmation service 1630, a member user affiliation management service 1632, and a swarm processing service 1634. As discussed above, application server 1516 may implement a web-based application (for example, hosting a corresponding website that includes a number of web pages, and a client system 1540 may include a web browser that renders a user interface implemented by the web-based application for allowing users access to the services provided by the application server 1516.

FIG. 16 further illustrates and exemplary embodiment inclusive of a data store 1514 which may comprise a plurality of databases that may be maintained and accessible by application server 1516 via database server 1512, including a member user database 1602, a trusted member database 1604, a user affiliation database 1606, an available services database 1608, a swarm information database, 1610, a swarm prediction database 1612, a geo-fence database, and one or more additional databases 1616 that may be used for storing any other suitable information that may be utilized by the server system 1510 (for example, system usage data, audit trail data, data used internally within the system by application server 1516, and the like). In one example, the various databases maintained within data store 1514 may be maintained as groups within one or more larger databases or maintained individually. For example, member user database 1602, trusted member database 1604, user affiliation database 1606, swarm information database 1610, and a geo-fence database may be maintained as a single group within a general profile database that may be maintained within the data store 1514.

As addressed below, application server 1516 may be configured to maintain various types of records and information within the plurality of databases. An information record may be, for example, a program and/or data structure that tracks various data related to a corresponding type of information record. As used herein, the terms “data,” “content,” “information,” and similar terms may be used interchangeably in order to refer to data capable of being captured, transmitted, received, displayed, and/or stored in accordance with various example embodiments provided herein. Thus, the use of any such terms should not be taken to limit the scope or nature of the disclosure. Further, where a computing device is described herein to receive data from another computing device, it will be appreciated that the data may be received directly from another computing device or may be received indirectly via one or more intermediary computing devices, such as, for example, one or more servers, relays, routers, network access points, base stations, and/or the like. Similarly, where a computing device is described herein to send data to another computing device, it will be appreciated that the data may be sent directly or indirectly to another computing device or may be sent indirectly via one or more intermediary computing devices such as one or more servers, relays, routers, network access points, base stations, and or the like for example.

As mentioned above, different types of users may access server system 1510. As such, application server 1516 may be configured to maintain and manage account information records for a variety of types of users that register with the system according to certain categories of accounts. In the present example embodiment, member user database 1602 may be used to maintain account information records for member users that register with server system 1510 to provide swarm information to the traffic information system 1500. For each member user and their associated demand observation system for which an account is registered with server system 1510, various items of information relevant to the member user and their demand observation system, such as user name, current locations, typical routes, and any other suitable identifying information as well as a unique username and password associated with the account that can be used to log into the account may be included in the respective account information record for the member user and their associated demand observation system that is maintained within the member user database 1602. The account information record for each user may also be associated with a unique user account identifier within member user database 1602 that is used by application server 1516 to perform various operations.

Trusted member database 1604 may be used to maintain records of member users and their associated demand observation systems within the traffic information system 1500. For each trusted member for which an account is registered with server system 1510, various items of information relevant to the trusted member, such as name, current location, known routes and other suitable information, as well as a unique user name and password associated with the trusted member may be included in the respective account information record for the user and their associated demand observation system that is maintained within the trusted member database 1604.

The user affiliation database 1606 of the data store 1514 of server system 1510 may be used to maintain records of member users and their associated demand observation system within the traffic information system to recognize the affiliation of the member users and their associated demand observation systems. For each affiliation group for which an account is registered with server system 1510, various items of information relevant to the service provider such as company name, area serviced, and number of users, as well as any other suitable information relevant to service providers may be stored. Each affiliation group may also be assigned a unique identifier to be maintained within the user affiliation database 1606.

Another example feature of data store 1514 is the available services database 1608, which may be used to maintain information records pertinent to the services offered by the traffic information system 1500. In exemplary embodiments, the respective information for swarm reporting services that are maintained in available services database 1608 and the information that populates the respective information record for each service can be created and maintained by a back-end administrator of server system 1510. For each service for which an information record is created, various items of information relevant to the service may be maintained within the available services database 1608.

Additionally, in example embodiments, a swarm information database 1610 may be provided. The swarm information database may be used to maintain records pertinent to the swarms reported to or predicted by the traffic information system 1500. In this example embodiment, the respective information for swarms including swarm location, swarm duration, and any other suitable information may be maintained by the swarm information database 1610. For each service for which an information record is created, various items of information relevant to the swarm may be maintained within the swarm information database 1610.

The data store 1514 provided in FIG. 16 may also comprise a swarm prediction database 1612. The swarm prediction database may be used to maintain records relevant to past swarms, current crowd sourced data (such as public transit arrival times, venue closing times) and any other pertinent information may be stored within the swarm prediction database. The information provided to a member user via the swarm prediction database may be created and maintained by a back-end system administrator. Further, for each swarm stored within the swarm prediction database 1612, may be stored within the swarm reporting database.

A geo-fence database 1614 may also be provided in exemplary embodiments in which information relevant to the supply of service providers (e.g., transportation service providers) and demand of service (e.g., transportation service demand) may be stored. The geo-fence database 1614 of the data store 1514 may be inclusive of information such as, for example, user names within a given area, estimated arrival times to the reported swarm and any other information relevant to the location of a swarm and the availability of member users to respond to a swarm.

Turning now to FIG. 17, this figure illustrates example processes followed by the DAE of a collective swarm reporting system and is a second example network architecture for a traffic information system. The example processes illustrated at FIG. 17 are very similar to the processes illustrated at FIG. 6.

FIG. 17 demonstrates how a DAE may utilize supplied data in order to provide users with alerts of new swarms, dissipated swarms, and predicted swarms for example. When information is supplied to the demand analytics engine (DAE) either from a user's demand observation system which reports a swarm or via third-party APIs and crowd-sourced data, the DAE may aggregate the supplied data and subsequently verify it. For example, if a user's demand observation system were to report a swarm location, but that same user and their associated demand observation system is not recognized by the DAE as a helpful contributing member of the collective swarm reporting system, the DAE may verify the data provided by waiting for additional incoming data from other alternative users' demand observation systems before producing an alert to other users within the system. As another example, if the DAE receives information from a plurality of third-party APIs, the DAE may then aggregate the data and based on the data supplied for a particular geo-fence, may predict and subsequently alert service providers of the predicted surge in demand.

Additional databases within the data store 1514 of server system 1510 may be provided. For example, the miscellaneous database 1616 as provided in FIG. 16 may store any additional information that may be pertinent to the supply and demand within the traffic information system 1500. For example, the miscellaneous database(s) 1616 may store and provide such information as weather, traffic times or any other suitable information that may impact, in one way or another, the supply and/or demand for a service.

An example of a graphical user interface provided by a homepage for member user portal may be accessible on a mobile computing device such as a smartphone. The homepage may include such links and buttons such as updates for the member user, and other information relevant to reporting and responding to a swarm.

As another example, a graphical user interface provided by a collective swarm reporting network may be shown. In some examples, buttons and links provided by the computing system and demand analytics engine of the collective swarm reporting system or network. In this example, third-party sourced data such as event data, rideshare service data, and public transportation data may be shown. Such third-party sourced data may include locations of current swarms as well as locations of future predicted swarms based on the data sourced from said third-party APIs.

A further example GUI may show example data supplied to a graphical user interface as supplied by the swarm reporting network. Such information may include the history of a member user's route, the number of hours worked, expenses accrued, and fuel consumed for example.

Additional information and data that may be supplied to the GUI of a computing device such as a smartphone may include example information and data such as estimated expenses, possible fees resultant from routes, and income.

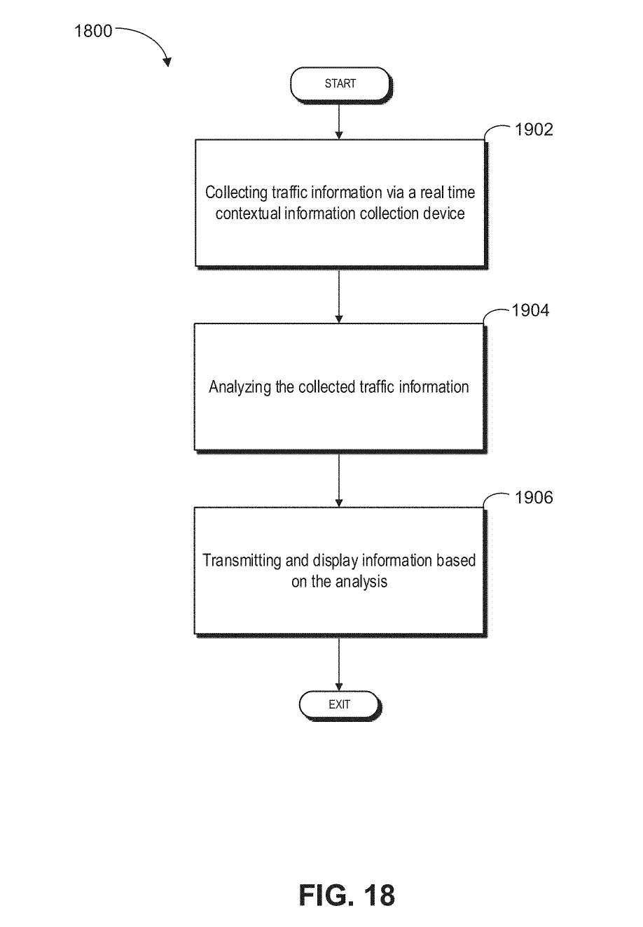

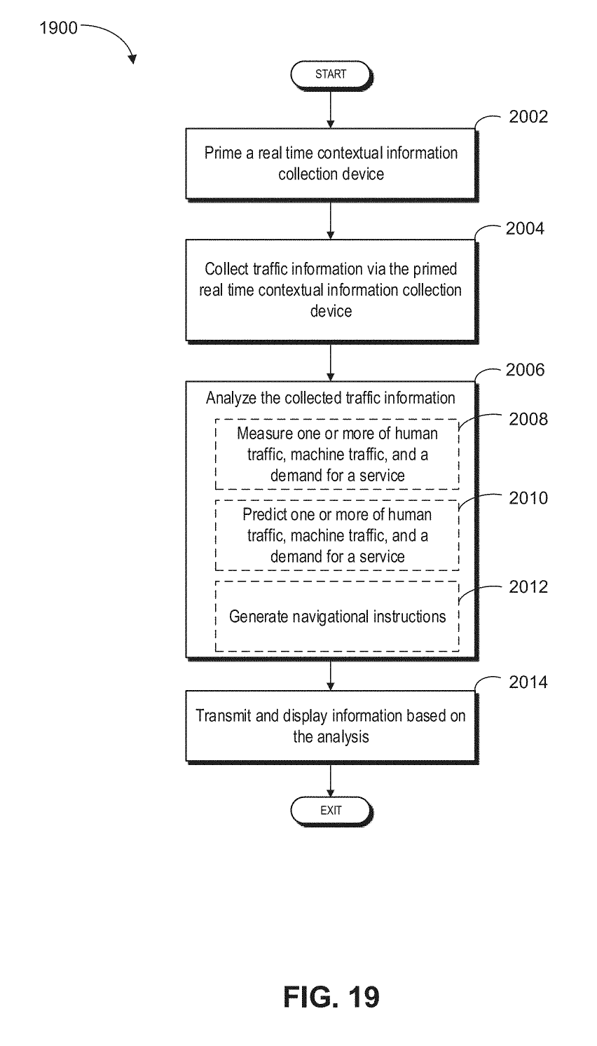

FIGS. 18 and 19 illustrate two example methods for measuring and predicting one or more of human traffic and machine traffic. In some examples, FIGS. 18 and 19 may be carried out via the traffic information system as described above.

Turning to FIG. 18, a flow chart of a first example method 1900 for measuring and predicting one or more of human and machine traffic is illustrated.

The method may begin at step 1902 wherein traffic information is collected. In some examples, the traffic information may be one or both of human and machine traffic. The traffic information may be collected passively via the real time contextual information collection device as described above in some examples. For example, detection of wireless signals may be utilized as traffic information. These wireless signals may be detected via at least one traffic sensor of the real time contextual information collection device. Additionally or alternatively, the traffic information may be collected via one or more of reporting users and third party sources, as described above.

Following collection of the traffic information at step 1902, the method may continue at step 1904 to analyze the collected traffic information. The collected traffic information may be analyzed via a rule driven decision module. For example, the collected traffic information may be analyzed via a rule driven decision module such as rule driven decision module 200. Additionally or alternatively, a request may also be analyzed at step 1904 of method 1900, as further described below.

The rule driven decision module may analyze the collected traffic information to measure one or more of human traffic and machine traffic. Put another way, the rule driven decision module may analyze the collected traffic information to estimate one or more of a current human traffic and machine traffic in a region. Such analysis may determine a crowding in a region. In other examples, the rule driven decision module may further analyze the collected traffic information in order to predict one or more of human traffic and machine traffic. For example, the rule driven decision module may analyze the collected traffic information to predict one or more of a future human traffic and machine traffic in a region (i.e., future crowding). Additionally or alternatively, the rule driven machine module may analyze the collected traffic information in order to measure a demand for a service in a region. For example, rule driven decision module may analyze the collected traffic information in order to estimate a current demand for a service in a region.

Further still, the rule driven decision module may additionally or alternatively analyze the collected traffic information in order to predict a demand for a service. In other words, based on the collected traffic information, a future demand for a service may be predicted. For example, in the transportation industry, a future demand for transportation in a region may be predicted. After step 1904, method 1900 continues on to transmit and display information based on the analysis at step 1906.

For example, transmitting information at 1906 may include communicating with one or more communication devices to transmit and display information based on the analysis at step 1904. In some embodiments, transmitting information may include displaying any one or combination of the results discussed above from the analyses at step 1904. However, in some embodiments, transmitting information at 1906 based on the analyses at step 1904 may include transmitting information via a network without displaying the information.

In some examples, generating a response at step 1906 may include alerting users of one or more of traffic conditions (e.g., human and/or machine traffic) and demand conditions (e.g., demand for a service) based on the analyses at step 1904. For example, if an elevated demand for a service is measured or predicted for a region at step 1904, this elevated demand (i.e., swarm or surge) condition may be communicated to users of the traffic information system. The users may be notified of such conditions via any one or combination of notification manners described above. For example, the users may be notified of regions that may have an elevated demand condition or an elevated traffic condition. Following generating a response at step 1906, method 1900 may proceed to exit.

Turning now to FIG. 19, a second example method for measuring and predicting one or more of an amount of human and machine traffic is illustrated. Following a start of method 2000, step 2002 of method 2000 may include priming a real time contextual information collection device. In some examples, priming the real time contextual information collection device may include any one or combination of the priming steps as described above. For example, priming the real time contextual information collection device may include uploading a rule set defining a specific context for data collection.

Following priming of the real time contextual information collection device at 2002, traffic information may be passively collected via the primed real time contextual information collection device at step 2004. For example, traffic information at step 2004 may be collected via at least one traffic sensor, as described above. Additionally or alternatively, traffic information, may be collected via one or both of users (e.g., user verified swarm conditions and swarm dissipation conditions) and third parties.

At step 2006, method 2000 may analyze the collected traffic information. Additionally or alternatively, a request may also be analyzed at step 2006, as further described below. The analysis at step 2006 may be carried out via the rule driven decision module 200, as described above. In some examples, the analysis may include measuring one or more of human traffic and machine traffic at step 2008. Additionally or alternatively, the analysis at step 2006 may include predicting one or more of human traffic, machine traffic, and a demand for service at step 2010.

Further, step 2012 of method 2000 may additionally or alternatively include analyzing the collected traffic information to generate navigational instructions. In one embodiment, generating navigational instructions at 2012 may further be based upon one or more of a request, user reported traffic information, and third party information. In some examples, the navigational instructions may be generated via a navigation generating engine of the rule driven decision module, as described above.

In at least one embodiment, the navigational instructions may be generated based on a request and one or more of the collected traffic information, user reported traffic information, and third party information. In some examples, the request may be a request to route a user towards one or more of elevated traffic and elevated demand regions. However, in other examples, the request may be to route a user to avoid one or more of elevated traffic and elevated demand regions. In some examples, these requests may be made via any one or combination of manners for receiving a user input as described above. Additionally, these requests may be made automatically. For example, the computing system of an autonomous may include programming enabling the autonomous vehicle to communicate with the traffic information system to automatically request to be routed to avoid elevated traffic and elevated demand regions, or to move towards elevated traffic and elevated demand regions.

Following analyzing the collected traffic information at step 2016, step 2014 of method 2000 may include transmitting and displaying information based on the analysis. For example, transmitting information at step 2014 may include alerting users of one or more of traffic conditions and demand conditions based on the analysis at step 2006. For example, if an elevated demand is measured or predicted in a region for a service at step 2006, this measured or predicted elevated demand (i.e., swarm or surge) condition may be communicated to users of the traffic information system via displaying a notification.

For example, step 2014 may include transmitting information such as discussed above at step 1906 of FIG. 19. In one example, transmitting information at 2014 may include displaying navigational instructions generated at step 2012 for a user. However, in some embodiments, transmitting information at 2014 based on the analysis may include transmitting information via a network without displaying the information. For example, at step 2014 navigational instructions may be transmitted to an autonomous vehicle without necessarily displaying the navigational instructions, and the autonomous vehicle may then follow the navigational instructions responsive to a user confirmation, for example. It should be appreciated, however, that in embodiments where an autonomous vehicle may receive transmitted information based on one or more of the analyses at step 2004, the autonomous vehicle may also display such information.

Following transmitting information based on the analysis at step 2014, method 2000 may proceed to exit.

Thus, provided is a real time contextual information system and methods. In at least one example, the system may include at least one signal scanner that passively scans and detects wireless signals within a region, the wireless signals emitted from communication devices and a central processing unit (CPU) in communication with the at least one signal scanner via network connectivity. The CPU may comprises instructions stored in non-transitory memory that are executable by the CPU to receive information transmitted from the at least one signal scanner, the information based on the detected wireless signals.

Receiving the information transmitted from the at least one signal scanner, as opposed to having to perform the scanning at a device of the CPU may allow the CPU itself to operate more efficiently. In some examples, the information transmitted from the at least one signals scanner to the CPU may first be filtered. Thus, a processing speed of the information at the CPU may be carried out in even a more expedient manner in such examples.

Furthermore, in at least one example, the instructions may be further executable by the CPU to estimate an amount of human traffic and machine traffic at the region based on the information, and display the estimation.

Additionally or alternatively, the instructions may be further executable to generate a model to predict a future demand for service in the region, the model generated based on the information, and the model further based on previously stored human traffic and machine traffic estimations for the region. In some examples, the model may be further generated based on contextual information. In at least one embodiment, the at least one signal scanner may collect one or more of radio signals, Wi-Fi signals, and Bluetooth signals emitted from the communication devices. The passive scanning may include where the at least one signal scanner automatically scans and transmits the information without user interaction.

In a further example, that may optionally include one or more of the previously mentioned examples, the instructions may be further executable to identify a current swarm event at the region responsive to the human traffic and the machine traffic being greater than a threshold amount of traffic The instructions may further be executable to generate and display navigational instructions to the region responsive to identifying the current swarm event at the region.

Additionally, a first example method may include passively collecting wireless information emitted by a plurality of wireless communication devices and one or more third party APIs based on a set of predetermined rules, storing the passively collected wireless information from the plurality of wireless communication devices and the one or more third party APIs to form a set of contextual data, creating a swarm event based on the set of contextual data, and displaying a notification of the swarm event.

In a second example method that may optionally include the first example method, the set of contextual data may comprise one or more of geographical location, wireless communication device density, movement, velocity, type of wireless communication device, duration of time spent within a specific geographical area, time of day, and weather conditions. In at least one example, the navigational instructions to the swarm event may be displayed.

In a further example method that may optionally include one or both of the first and second methods, such a method may include tracking, calibrating, and tailoring traffic estimations based on the set of contextual data, where the swarm event is created based on the traffic estimations. In at least one example method that may optionally include any one or combination of the previous methods, the swarm event may be ended based on the traffic estimations, and the swarm event notification may be modified to reflect the ending of the swarm event. For example, the swarm event may be created responsive to human and/or machine traffic greater than a threshold, and the swarm event may be ended responsive to human and/or machine traffic less than a threshold. In another example, the swarm event may be created responsive to a demand for service being greater than a threshold, and the swarm event may be ended responsive to a demand for service being less than the threshold. It is noted that the demand for service may be at least partially based on one or more of human traffic, machine traffic, and contextual data. Additionally or alternatively, a method that may include any one or combination of the previous methods may include predicting and displaying a notification of a future swarm event based on the set of contextual data. Such methods may include displaying navigational instructions to the future swarm event, for example.

In another example, a method may comprise receiving one or more sets of predefined rules and contextual information, passively collecting wireless signal data emitted from one or more wireless communication devices, sourcing and collecting additional contextual information from a plurality of third party APIs, aggregating and verifying the passively collected wireless signal data and the additional contextual information, predicting a potential swarm using the aggregated and verified wireless signal data and additional contextual information, and providing an alert indicating the potential swarm via a display. The method may further comprise displaying navigational instructions to the potential swarm, where the potential swarm is a region predicted to have greater than a threshold amount of traffic.

In another example method that may include any one or combination of the previous example methods, the one or more sets of predefined rules and contextual information may comprise one or more of geographical location, wireless communication device density, movement, velocity, type of wireless communication device, duration of time spent within a specific geographical area, time of day, and weather conditions. In a further example method that may include one or more of the previous example methods, such a method may include identifying a current swarm using the aggregated and verified wireless signal data and additional contextual information. Additionally, another example method may include providing navigational instructions to the current swarm via a display, the current swarm being a region comprising greater than a threshold amount of traffic. Furthermore, in at least one example method, the navigational instructions to the current swarm may avoid traffic between a starting location and the current swarm. Thus, a user may be able to navigate to the swarm event (crowded region) in an efficient manner.

As used herein, an element or step recited in the singular and proceeded with the word “a” or “an” should be understood as not excluding a plurality of said elements or steps, unless such exclusion is explicitly stated. Furthermore, references to “one embodiment” of the present disclosure are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property. The terms “including” and “in which” are used herein as the plain language equivalents of the respective terms “comprising” and “wherein.” Moreover, the terms “first,” “second,” and “third,” etc. are used merely as labels, and are not intended to impose numerical requirements or a particular positional order on their objects.

This written description uses examples to disclose the subject matter, including best mode, and also to enable a person of ordinary skill in the relevant art to practice the subject matter, including making and using any devices or systems and performing any incorporated methods. The patentable scope of the subject matter is defined uniquely by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal language of the claims.

1. A real time contextual information system, comprising:
at least one signal scanner that passively scans and detects wireless signals within a region, the wireless signals emitted from communication devices;
a central processing unit (CPU) in communication with the at least one signal scanner via network connectivity, where the CPU comprises instructions stored in non-transitory memory that are executable by the CPU to:
receive information transmitted from the at least one signal scanner, the information based on the detected wireless signals,
estimate an amount of human traffic and machine traffic at the region based on the information, and
display the estimation.

2. The system of claim 1, where the instructions are further executable to generate a model to predict a future demand for service in the region, the model generated based on the information, and the model further based on previously stored human traffic and machine traffic estimations for the region.

3. The system of claim 2, wherein the model is further generated based on contextual information.

4. The system of claim 1, wherein the at least one signal scanner collects one or more of radio signals, Wi-Fi signals, and Bluetooth signals emitted from the communication devices.

5. The system of claim 1, wherein the passive scanning includes the at least one signal scanner automatically scanning and transmitting the information without user interaction.

6. The system of claim 1, where the instructions are further executable to identify a current swarm event at the region responsive to the human traffic and the machine traffic being greater than a threshold amount of traffic.

7. The system of claim 6, where the instructions are further executable to generate and display navigational instructions to the region responsive to identifying the current swarm event at the region.

8. A method, comprising:
passively collecting wireless information emitted by a plurality of wireless communication devices and one or more third party APIs based on a set of predetermined rules;
storing the passively collected wireless information from the plurality of wireless communication devices and the one or more third party APIs to form a set of contextual data;
creating a swarm event based on the set of contextual data; and
displaying a notification of the swarm event.

9. The method of claim 8, wherein the set of contextual data comprises one or more of geographical location, wireless communication device density, movement, velocity, type of wireless communication device, duration of time spent within a specific geographical area, time of day, and weather conditions.

10. The method of claim 8, further comprising displaying navigational instructions to the swarm event.

11. The method of claim 8, further comprising automatically tracking, calibrating, and tailoring traffic estimations based on the set of contextual data, where the swarm event is created based on the traffic estimations.

12. The method of claim 11, further comprising ending the swarm event based on the traffic estimations, and modifying the swarm event notification to reflect the ending of the swarm event.

13. The method of claim 8, further comprising predicting and displaying a notification of a future swarm event based on the set of contextual data.

14. The method of claim 13, further comprising displaying navigational instructions to the future swarm event.

15. A method, comprising:
receiving one or more sets of predefined rules and contextual information;
passively collecting wireless signal data emitted from one or more wireless communication devices;
sourcing and collecting additional contextual information from a plurality of third party APIs;
aggregating and verifying the passively collected wireless signal data and the additional contextual information;
predicting a potential swarm using the aggregated and verified wireless signal data and additional contextual information; and
providing an alert indicating the potential swarm via a display.

16. The method of claim 15, further comprising displaying navigational instructions to the potential swarm, where the potential swarm is a region predicted to have greater than a threshold amount of traffic.

17. The method of claim 15, wherein the one or more sets of predefined rules and contextual information comprises one or more of geographical location, wireless communication device density, movement, velocity, type of wireless communication device, duration of time spent within a specific geographical area, time of day, and weather conditions.

18. The method of claim 15, further comprising identifying a current swarm using the aggregated and verified wireless signal data and additional contextual information.

19. The method of claim 18, further comprising providing navigational instructions to the current swarm via a display, the current swarm being a region comprising greater than a threshold amount of traffic.

20. The method of claim 19, wherein the navigational instructions to the current swarm avoid traffic between a starting location and the current swarm.
